(19) United States
(12) Patent Application Publication
(10) Pub. No.: US 2025/0301427 A1
(43) Pub. Date: Sep. 25, 2025

(54) INFORMATION TRANSMISSION METHOD AND APPARATUS, TERMINAL, AND NETWORK-SIDE DEVICE

(71) Applicant: VIVO MOBILE COMMUNICATION CO., LTD., Guangdong (CN)

(72) Inventors: Pengfei WANG, Guangdong (CN); Kun YANG, Guangdong (CN); Dajie JIANG, Guangdong (CN)

(73) Assignee: VIVO MOBILE COMMUNICATION CO., LTD., Guangdong (CN)

(21) Appl. No.: 19/231,069

(22) Filed: Jun. 6, 2025

Related U.S. Application Data
(63) Continuation of application No. PCT/CN2023/135260, filed on Nov. 30, 2023.

(30) Foreign Application Priority Data
Dec. 6, 2022 (CN) 202211580718.3

(51) Int. Cl. H04W 56/00; H04W 74/0833

(52) U.S. Cl. CPC H04W 56/001; H04W 74/0833

(57) ABSTRACT

An information transmission method and apparatus, a terminal, and a network-side device. The information transmission method in embodiments of this application includes: receiving, by a terminal, first indication information sent by a network-side device via system information associated with a first-stage synchronization signal and/or a second-stage synchronization signal, where the first indication information is used to indicate an adjusted sending configuration parameter of the second-stage synchronization signal.

### CROSS-REFERENCE TO RELATED APPLICATIONS

This application is a continuation of International Application No. PCT/CN2023/135260 filed on Nov. 30, 2023, which claims priority to Chinese Patent Application No. 202211580718.3 filed on Dec. 6, 2022, which are incorporated herein by reference in their entireties.

### TECHNICAL FIELD

This application pertains to the field of communication technologies, and specifically relates to an information transmission method and apparatus, a terminal, and a network-side device.

### BACKGROUND

In a cell-free network, density of transmission and reception points (TRP) may be very high, but synchronization signal resources are limited. Therefore, as a quantity of TRPs increases, sizes of cells are further reduced, so that same synchronization signal resources are reused in different cells. However, as the quantity of TRPs increases, a quantity of sent synchronization signals also increases. Consequently, when sending and receiving signals, a transmit end and a receive end need to consume a lot of resources, and power consumption of the transmit end and the receive end is high during synchronization signal transmission.

### SUMMARY

Embodiments of this application provide an information transmission method and apparatus, a terminal, and a network-side device.

According to a first aspect, an embodiment of this application provides an information transmission method. The method includes:
receiving, by a terminal, first indication information sent by a network-side device via system information associated with a first-stage synchronization signal and/or a second-stage synchronization signal, where the first indication information is used to indicate an adjusted sending configuration parameter of the second-stage synchronization signal, where the sending configuration parameter includes at least one of the following:
a synchronization raster;
a frequency-domain position;
a time-domain position;
a time-domain offset and/or a frequency-domain offset of the second-stage synchronization signal relative to the first-stage synchronization signal;
a mapping relationship between an index set of the first-stage synchronization signal and an index set of the second-stage synchronization signal;
a quantity of second-stage synchronization signals;
a sending period; and
a transmission state, where the transmission state includes: sending enabled or sending disabled.

According to a second aspect, an embodiment of this application provides an information transmission apparatus, applied to a terminal. The apparatus includes:
a first receiving module, configured to receive first indication information sent by a network-side device via system information associated with a first-stage synchronization signal and/or a second-stage synchronization signal, where the first indication information is used to indicate an adjusted sending configuration parameter of the second-stage synchronization signal, where
the sending configuration parameter includes at least one of the following:
a synchronization raster;
a frequency-domain position;
a time-domain position;
a time-domain offset and/or a frequency-domain offset of the second-stage synchronization signal relative to the first-stage synchronization signal;
a mapping relationship between an index set of the first-stage synchronization signal and an index set of the second-stage synchronization signal;
a quantity of second-stage synchronization signals;
a sending period; and
a transmission state, where the transmission state includes: sending enabled or sending disabled.

According to a third aspect, an embodiment of this application provides an information transmission method. The method includes:
sending, by a network-side device, first indication information to a terminal via system information associated with a first-stage synchronization signal and/or a second-stage synchronization signal, where the first indication information is used to indicate an adjusted sending configuration parameter of the second-stage synchronization signal, where
the sending configuration parameter includes at least one of the following:
a synchronization raster;
a frequency-domain position;
a time-domain position;
a time-domain offset and/or a frequency-domain offset of the second-stage synchronization signal relative to the first-stage synchronization signal;
a mapping relationship between an index set of the first-stage synchronization signal and an index set of the second-stage synchronization signal;
a quantity of second-stage synchronization signals;
a sending period; and
a transmission state, where the transmission state includes: sending enabled or sending disabled.

According to a fourth aspect, an embodiment of this application provides an information transmission apparatus, applied to a network-side device. The apparatus includes:
a first sending module, configured to send first indication information to a terminal via system information associated with a first-stage synchronization signal and/or a second-stage synchronization signal, where the first indication information is used to indicate an adjusted sending configuration parameter of the second-stage synchronization signal, where
the sending configuration parameter includes at least one of the following:
a synchronization raster;
a frequency-domain position;
a time-domain position;
a time-domain offset and/or a frequency-domain offset of the second-stage synchronization signal relative to the first-stage synchronization signal;
a mapping relationship between an index set of the first-stage synchronization signal and an index set of the second-stage synchronization signal;
a quantity of second-stage synchronization signals;
a sending period; and
a transmission state, where the transmission state includes: sending enabled or sending disabled.

According to a fifth aspect, an embodiment of this application provides a terminal, including a processor and a memory. The memory stores a program or instructions capable of running on the processor. When the program or instructions are executed by the processor, the steps of the method according to the first aspect are implemented.

According to a sixth aspect, an embodiment of this application provides a terminal, including a processor and a communication interface. The communication interface is configured to receive first indication information sent by a network-side device via system information associated with a first-stage synchronization signal and/or a second-stage synchronization signal, where the first indication information is used to indicate an adjusted sending configuration parameter of the second-stage synchronization signal, where
the sending configuration parameter includes at least one of the following:
a synchronization raster;
a frequency-domain position;
a time-domain position;
a time-domain offset and/or a frequency-domain offset of the second-stage synchronization signal relative to the first-stage synchronization signal;
a mapping relationship between an index set of the first-stage synchronization signal and an index set of the second-stage synchronization signal;
a quantity of second-stage synchronization signals;
a sending period; and
a transmission state, where the transmission state includes: sending enabled or sending disabled.

According to a seventh aspect, an embodiment of this application provides a network-side device, including a processor and a memory. The memory stores a program or instructions capable of running on the processor. When the program or instructions are executed by the processor, the steps of the method according to the third aspect are implemented.

According to an eighth aspect, an embodiment of this application provides a network-side device, including a processor and a communication interface. The communication interface is configured to send first indication information to a terminal via system information associated with a first-stage synchronization signal and/or a second-stage synchronization signal, where the first indication information is used to indicate an adjusted sending configuration parameter of the second-stage synchronization signal, where
the sending configuration parameter includes at least one of the following:
a synchronization raster;
a frequency-domain position;
a time-domain position;
a time-domain offset and/or a frequency-domain offset of the second-stage synchronization signal relative to the first-stage synchronization signal;
a mapping relationship between an index set of the first-stage synchronization signal and an index set of the second-stage synchronization signal;
a quantity of second-stage synchronization signals;
a sending period; and
a transmission state, where the transmission state includes: sending enabled or sending disabled.

According to a ninth aspect, an embodiment of this application provides an information transmission system, including a terminal and a network-side device. The terminal may be configured to perform the steps of the method according to the first aspect. The network-side device may be configured to perform the steps of the method according to the third aspect.

According to a tenth aspect, an embodiment of this application provides a readable storage medium. The readable storage medium stores a program or instructions. When the program or instructions are executed by a processor, the steps of the method according to the first aspect or the third aspect are implemented.

According to an eleventh aspect, an embodiment of this application provides a chip. The chip includes a processor and a communication interface. The communication interface is coupled to the processor. The processor is configured to run a program or instructions to implement the steps of the method according to the first aspect or the third aspect.

According to a twelfth aspect, an embodiment of this application provides a computer program or program product. The computer program or program product is stored in a storage medium. The computer program or program product is executed by at least one processor to implement the steps of the method according to the first aspect or the third aspect.

### BRIEF DESCRIPTION OF DRAWINGS

FIG. 1 is a block diagram of a wireless communication system to which an embodiment of this application may be applied;

FIG. 2 is a schematic diagram of a structure of an NR SSB;

FIG. 3 is a schematic diagram of composition of a PBCH;

FIG. 4 is a schematic diagram of a four-step random access procedure;

FIG. 5 is a schematic diagram of a two-step random access procedure;

FIG. 6 is a first schematic flowchart of an information transmission method according to an embodiment of this application;

FIG. 7 is a first schematic diagram of a RACH switching procedure with two-stage synchronization signals;

FIG. 8 is a second schematic diagram of a RACH switching procedure with two-stage synchronization signals;

FIG. 9 is a second schematic flowchart of an information transmission method according to an embodiment of this application;

FIG. 10 is a first schematic modular diagram of an information transmission apparatus according to an embodiment of this application;

FIG. 11 is a schematic diagram of a structure of a terminal according to an embodiment of this application;

FIG. 12 is a second schematic modular diagram of an information transmission apparatus according to an embodiment of this application;

FIG. 13 is a schematic diagram of a structure of a network-side device according to an embodiment of this application; and

FIG. 14 is a schematic diagram of a structure of a communication device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “and/or” in the specification and claims indicates at least one of connected objects, and the character “/” generally represents an “or” relationship between associated objects.

It should be noted that technologies described in the embodiments of this application are not limited to a long term evolution (LTE)/LTE-Advanced (LTE-A) system, and can also be used in other wireless communication systems, such as code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” in the embodiments of this application are usually used interchangeably. The described technologies may be used for the foregoing systems and radio technologies, and may also be used for other systems and radio technologies. However, in the following descriptions, the new radio (NR) system is described for an illustrative purpose, and NR terms are used in most of the following descriptions. These technologies may also be applied to other applications than an NR system application, for example, a 6th Generation (6G) communication system.

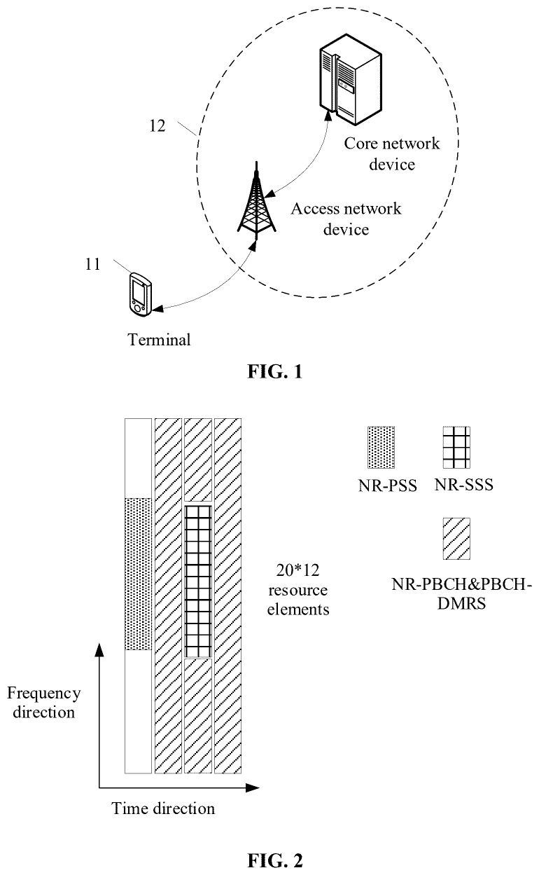

FIG. 1 is a block diagram of a wireless communication system to which an embodiment of this application may be applied. The wireless communication system includes a terminal 11 and a network-side device 12. The terminal 11 may be a terminal-side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR) or virtual reality (VR) device, a robot, a wearable device, vehicle user equipment (VUE), pedestrian user equipment (PUE), a smart home (a home device having a wireless communication function, such as a refrigerator, a television, a washing machine, or furniture), a game console, a personal computer (PC), a teller machine, a self-service machine, a sensing service terminal, various sensors, or a smart camera. The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, or the like. It should be noted that a specific type of the terminal 11 is not limited in the embodiments of this application. The network-side device 12 may include an access network device or a core network device. The access network device may also be referred to as a radio access network device, a radio access network (RAN), a radio access network function, or a radio access network element. The access network device may include a base station, a wireless local area network (WLAN) access point, a Wireless Fidelity (Wi-Fi) node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a TRP, a sensing signal sending device, a sensing signal receiving device, or another appropriate term in the art. As long as the same technical effect is achieved, the base station is not limited to specific technical terms. It should be noted that in the embodiments of this application, only a base station in an NR system is used as an example for description, but a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), or the like.

The following first describes technologies related to the embodiments of this application.

### 1. Cell-Free Massive ( ) Multiple-Input Multiple-Output (MIMO) System

A cell-free massive MIMO system may be considered as a deconstruction of a conventional massive MIMO system. In the conventional massive MIMO system, antennas are centrally deployed at one site (base station), and user equipment (UE, also referred to as terminals) is distributed around the base station in the form of cells. In a massive MIMO system, a large quantity of antennas are deployed for each base station. Therefore, a higher array gain and spatial resolution are provided. A plurality of UEs can be simultaneously served on a same time-frequency resource. A high throughput, high reliability, and high energy efficiency are provided. The cell-free massive MIMO system breaks the concept of cells. A large quantity of antennas are distributed in a wide area, and UE is also distributed in this wide area. These antennas are referred to as TRPs or access points (AP). Theoretically, each UE can communicate with every AP. With the help of a fronthaul network and a central processing unit (CPU), a large quantity of geographically distributed TRPs can jointly serve a small quantity of UEs, and the CPU uses channel statistics for joint detection. It is expected that cell-free massive MIMO networks will be applied to next-generation indoor and hotspot coverage scenarios, such as smart factories, railway stations, shopping malls, stadiums, subways, hospitals, community centers, or university campuses.

### 2. Cell Search and Synchronization Procedures in a 5th Generation (5G) NR Technology

In an existing 5G NR technology, to implement downlink synchronization, UE needs to obtain a frequency of an access carrier by searching for a synchronization signal/physical broadcast channel block (SS/PBCH Block or SSB). Due to a wide spectrum range of NR, to reduce search complexity, the UE performs SSB search based on a frequency spacing specified in a protocol, where the frequency spacing is referred to as a synchronization raster. The UE detects reference signal received power (SS-RSRP) of a synchronization signal at a corresponding frequency based on the synchronization raster, and selects an appropriate SSB based on a threshold (rsrp-ThresholdSSB) configured by a network. To be specific, if signal quality SS-RSRP of one SSB is higher than the threshold, the SSB meeting the condition is selected; if a plurality of SSBs meet the condition, one SSB is selected (the selection scheme is determined by a terminal implementation); or if no SSB meets the condition, one SSB is selected from a full set of SSBs (the selection scheme is determined by a terminal implementation). Based on an association relationship between the SSB and a random access channel occasion (RO), the UE determines a RO resource set and a preamble resource set associated with the SSB; and the UE randomly selects a RO resource and a preamble resource from the resource sets, sends a message 1 (Msg 1), and initiates a random access procedure.

### 3. SSB Structure in the 5G NR Technology

An initial search procedure is completed based on an SSB. The SSB includes a primary synchronization signal (PSS), a secondary synchronization signal (SSS), a physical broadcast channel (PBCH), and a demodulation reference signal (DMRS) on four consecutive orthogonal frequency division multiplexing (OFDM) symbols. The SSB is mainly used for downlink synchronization. FIG. 2 shows a structure of an SSB.

The SSB includes a PSS, an SSS, a PBCH, and a physical broadcast channel demodulation reference signal (PBCH-DMRS). Main functions of the PSS and the SSS are to implement symbol-level synchronization and determine a physical cell identity (PCI). As shown in FIG. 3, the PBCH includes a master information block (MIB) of a cell and some other information. The PBCH-DMRS is used as a demodulation reference signal for the PBCH, and includes some SSB index information (higher three bits).

### 4. Random Access Channel (RACH) Procedure

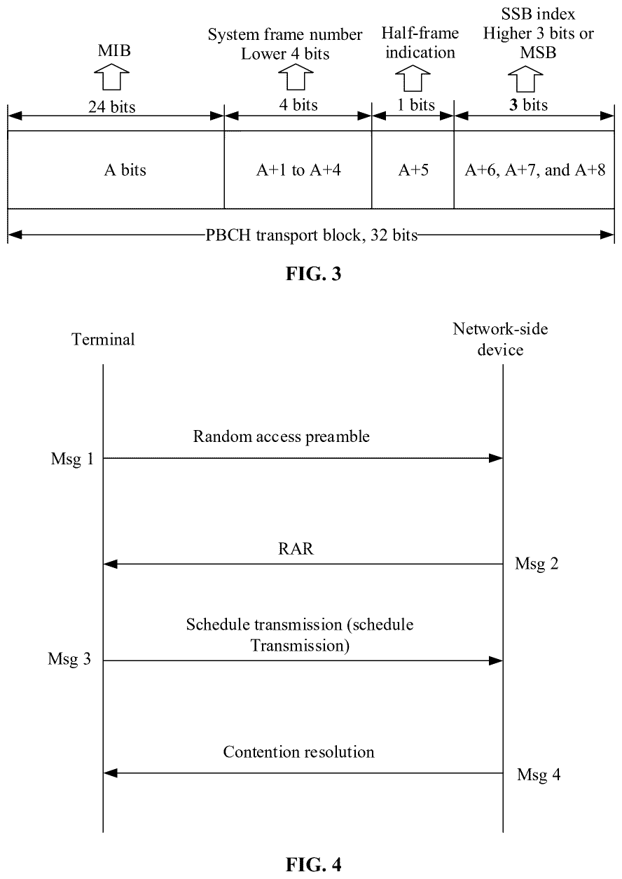

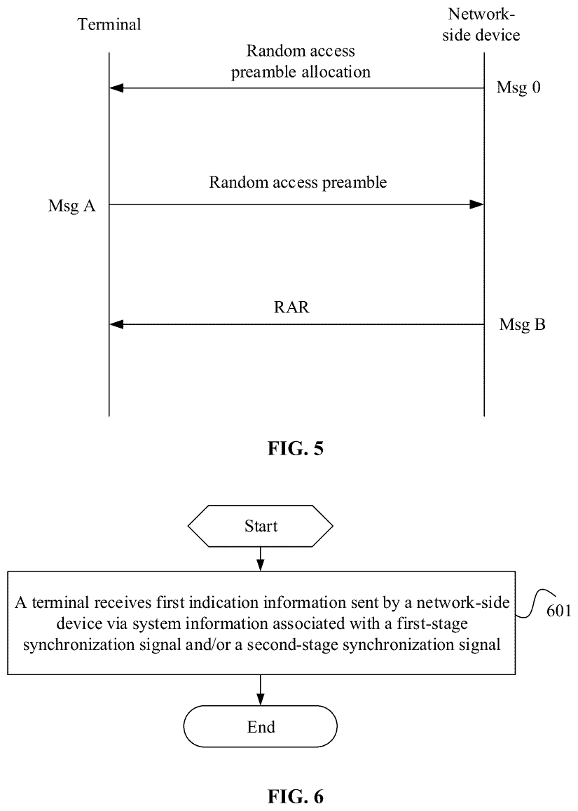

Currently, a RACH procedure is divided into a contention-based random access procedure and a contention-free random access procedure. The contention-based random access procedure is four-step access including a message 1 to a message 4, as shown in FIG. 4. The contention-free random access procedure is two-step access including a message 1 and a message 2, as shown in FIG. 5.

Both the message 2 in contention-based random access and the message 2 in contention-free random access are to send a random access response (RAR). Within a RAR window, UE monitors a RAR corresponding to a random access radio network temporary identifier (RA-RNTI).

Because there is a problem that UEs send a same preamble on a same physical random access channel (PRACH) resource in contention-based random access, the UE further needs to send the message 3 based on an uplink grant (UL grant) in the message 2 after receiving the message 2, and the UE may carry an identity of the UE in the message 3, and start a contention resolution timer while sending the message 3. Before the contention resolution timer expires, if the UE receives the message 4 sent by the base station, it indicates that the UE contention resolution is successful. The base station may carry the UE identity in the message 4, and the UE may determine, based on the UE identity carried in the message 4, whether the message 4 is intended for the UE itself, to determine whether the contention is successful.

Further, to shorten a system access delay, a two-step RACH is introduced, that is, a RACH procedure includes two steps: a terminal sends a Msg A to a network-side device and then receives a Msg B sent by the network-side device. The Msg A includes functions of the foregoing Msg 1 or Msg 1 and Msg 3. The Msg B includes functions of the foregoing Msg 2 or Msg 2 and Msg 4.

An information transmission method and apparatus, a terminal, and a network-side device provided in the embodiments of this application are hereinafter described in detail by using some embodiments and application scenarios thereof with reference to the accompanying drawings.

As shown in FIG. 6, an embodiment of this application provides an information transmission method, including:

Step 601: A terminal receives first indication information sent by a network-side device via system information associated with a first-stage synchronization signal and/or a second-stage synchronization signal, where the first indication information is used to indicate an adjusted sending configuration parameter of the second-stage synchronization signal.

The sending configuration parameter includes at least one of the following:

A11. A synchronization raster (Sync raster).

A12. A frequency-domain position.

A13. A time-domain position.

It should be noted that A11 to A13 above may be understood as explicit information indicating an adjusted resource position of the second-stage synchronization signal.

A14. A time-domain offset and/or a frequency-domain offset of the second-stage synchronization signal relative to the first-stage synchronization signal.

A15. A mapping relationship between an index set of the first-stage synchronization signal and an index set of the second-stage synchronization signal.

It should be noted that A14 and A15 above may be understood as implicit information indicating the adjusted resource position of the second-stage synchronization signal.

A16. A quantity of second-stage synchronization signals.

A17. A sending period.

A18. A transmission state, where the transmission state includes: sending enabled or sending disabled.

It should be noted that the network-side device may send information about the adjusted resource position of the second-stage synchronization signal (that is, at least one of A11 to A17 above); or the network-side device may send an indication to enable or disable the second-stage synchronization signal, so as to reduce power consumption of the network-side device in a case that the second-stage synchronization signal does not need to be sent.

It should be noted that this embodiment of this application is provided on a basis that the network-side device sends the first-stage synchronization signal and the second-stage synchronization signal. Usually, the terminal receives the first-stage synchronization signal sent by the network-side device to obtain signal quality of the first-stage synchronization signal; and determines, based on the signal quality, whether to detect the second-stage synchronization signal.

The signal quality includes at least one of the following:
reference signal received power (RSRP);
reference signal received quality (RSRQ); and
a signal to interference plus noise ratio (SINR).

It should be noted that, setting the two-stage synchronization signals and determining, based on the signal quality of the first-stage synchronization signal, whether to detect the second-stage synchronization signal can reduce complexity of network deployment, reduce interference between the synchronization signals, and improve reliability of random access of the terminal.

Specifically, in a case that the signal quality of the first-stage synchronization signal is less than a first threshold, the terminal detects the second-stage synchronization signal. In other words, the terminal detects the second-stage synchronization signal only in the case that the signal quality of the first-stage synchronization signal is less than the first threshold, and does not detect the second-stage synchronization signal in a case that the signal quality of the first-stage synchronization signal is greater than or equal to the first threshold, so that power consumption caused by the detection of the second-stage synchronization signal can be further reduced without affecting data transmission of the terminal.

Optionally, the first-stage synchronization signal is jointly sent by a TRP cluster, and the second-stage synchronization signal is sent by at least one TRP in the TRP cluster.

It should be noted that TRPs in each TRP cluster can support data transmission in a coherent joint transmission (CJT) mode, which can increase coverage of synchronization signals. Conversely, within same coverage, lower transmit power of synchronization signals is required. In this case, compared with the first-stage synchronization signal, the second-stage synchronization signal may use a narrower beam than the first-stage synchronization signal. Allocating first-stage synchronization signal resources based on the TRP cluster can implement synchronization signal expansion in a network with dense TRPs, without adding new cells, thereby reducing complexity of network deployment. Moreover, coherent transmission by TRPs and establishment of a terminal cooperation cluster can be better supported. The second-stage synchronization signal can use a narrower beam width, and the terminal side can detect higher RSRP and a more accurate beam direction, which is beneficial to improving transmission reliability.

Optionally, the second-stage synchronization signal is reused among different TRP clusters. It should be noted that, this case may be understood as: different first-stage synchronization signals may be associated with the same second-stage synchronization signal. In this way, the search time for the second-stage synchronization signal can be further reduced.

Optionally, the first-stage synchronization signal and the second-stage synchronization signal meet at least one of the following:

B11. A quantity of candidate positions of a synchronization raster of the first-stage synchronization signal is less than that of the synchronization raster of the second-stage synchronization signal.

In other words, the second-stage synchronization signal may use a sync raster different from that of the first-stage synchronization signal. This setting enables the terminal to search for the first-stage synchronization signal more quickly and reduces the search time for the synchronization signal.

B12. Frequencies of the first-stage synchronization signal and the second-stage synchronization signal are different.

For example, the first-stage synchronization signal may be deployed at a lower frequency and the second-stage synchronization signal may be deployed at a higher frequency.

It should be noted that this setting can support a layered cell-free network. For example, the first-stage synchronization signal is sent through a first-layer network in a single frequency network (SFN) mode, and the second-stage synchronization signal is sent through a second-layer network in a non-SFN mode. For example, the first-stage synchronization signal is sent through a first-layer network at a relatively low frequency, and the second-stage synchronization signal is sent through a second-layer network at a relatively high frequency.

B13. The first-stage synchronization signal and the second-stage synchronization signal use different synchronization signal resources.

For example, Total quantity of synchronization signals=Quantity of first-stage synchronization signals+Quantity of second-stage synchronization signals.

B14. The first-stage synchronization signal and the second-stage synchronization signal jointly indicate cell identification information.

In other words, the two-stage synchronization signals may jointly indicate the cell identification information (Cell ID). For example, a PSS is indicated in the first-stage synchronization signal, and an SSS is indicated in the second-stage synchronization signal. In this case, the terminal needs to detect the two-stage synchronization signals before determining the cell ID.

B15. The first-stage synchronization signal and the second-stage synchronization signal respectively indicate cell identification information.

In other words, the cell ID may also be indicated in each of the two-stage synchronization signals. For example, the PSS and the SSS are indicated in both the first-stage synchronization signal and the second-stage synchronization signal. In this case, the terminal can determine the cell ID by detecting either of the two-stage synchronization signals.

Optionally, in another embodiment of this application, after the terminal receives the first indication information sent by the network-side device via the system information associated with the first-stage synchronization signal and/or the second-stage synchronization signal, the method further includes:
the terminal determines a resource position of the second-stage synchronization signal based on the sending configuration parameter, where the resource position includes a time-domain position and/or a frequency-domain position; and
the terminal detects the second-stage synchronization signal based on the resource position of the second-stage synchronization signal.

It should be noted that the foregoing case may be understood as: the network-side device actively adjusts sending of the second-stage synchronization signal. Optionally, the network-side device may send the first indication information to the terminal based on an access status of the terminal.

For example, the network-side device may dynamically adjust the sending period and/or the quantity of second-stage synchronization signals based on the access status of the terminal.

It should also be noted that different first-stage synchronization signals can support separate configurations of second-stage synchronization signals, and that adjusted sending configuration parameters of the second-stage synchronization signals under each first-stage synchronization signal may be different, such as the quantity of second-stage synchronization signals, the frequency-domain position, the time-domain position, the time-domain offset and/or frequency-domain offset relative to the first-stage synchronization signal.

The following illustrates a specific implementation in which the network-side device dynamically adjusts the sending period and the quantity of second-stage synchronization signals.

### 1. The Network-Side Device Dynamically Adjusts the Quantity of Second-Stage Synchronization Signals.

Optionally, the network-side device may increase or decrease the quantity of second-stage synchronization signals in a sending period based on the access status of the terminal. For example, when no terminal performs access based on the first-stage synchronization signal and the second-stage synchronization signal associated with the first-stage synchronization signal in N consecutive periods (N is configured by the network-side device or defined in a protocol), the network-side device may decrease the quantity of second-stage synchronization signals to 1/M of the original quantity (where M>1, and M is configured by the network-side device or defined in a protocol), or decrease the quantity of second-stage synchronization signals to S (where S is an integer greater than or equal to 1, and configured by the network-side device or defined in a protocol). For example, when the network-side device detects that a plurality of terminals perform access based on the same second-stage synchronization signal and that preamble contention occurs, a quantity of second-stage synchronization signals adjacent to the second-stage synchronization signal may be increased.

Optionally, the network-side device may indicate an updated quantity of second-stage synchronization signals, an updated time-domain position, an updated frequency-domain position, or the like in a resource (such as a corresponding MIB, SIB, or other messages) associated with the first-stage synchronization signal and/or the second-stage synchronization signal. The terminal performs detection based on the updated quantity of second-stage synchronization signals, the updated time-domain position, or the updated frequency-domain position. A terminal that has performed access based on the second-stage synchronization signal may receive the adjusted quantity, time-domain position, frequency-domain position, or the like via the resource associated with the second-stage synchronization signal.

Optionally, the network-side device may also uniformly adjust the quantity of second-stage synchronization signals associated with all first-stage synchronization signals. For example, based on a quantity of users and/or traffic conditions of the entire network, the network-side device adjusts the quantity of second-stage synchronization signals associated with all the first-stage synchronization signals, and may indicate the updated quantity of second-stage synchronization signals in the resource (such as the corresponding MIB, SIB, or other messages) associated with the first-stage synchronization signal and/or second-stage synchronization signal.

### 2. The Network-Side Device Dynamically Adjusts the Sending Period of the Second-Stage Synchronization Signal and Enables or Disables the Second-Stage Synchronization Signal.

Optionally, the network-side device may increase or decrease the sending period of the second-stage synchronization signal based on the access status of the terminal, and may also disable or enable the second-stage synchronization signal. For example, when no terminal performs access based on the first-stage synchronization signal and the second-stage synchronization signal associated with the first-stage synchronization signal in J (J is configured by the network-side device or defined in a protocol) consecutive periods, the network-side device may adjust the sending period of the second-stage synchronization signal associated with the first-stage synchronization signal to be K times that of the first-stage synchronization signal (where K>1, and K is configured by the network-side device or defined in a protocol), or suspend sending of the second-stage synchronization signal corresponding to the first-stage synchronization signal. In a period in which sending of the second-stage synchronization signal is suspended, the network-side device stops sending information (which may include, for example, at least one of A11 to A17) about the second-stage synchronization signal associated with the first-stage synchronization signal in the resource associated with the first-stage synchronization signal (such as the MIB, SIB, or other messages).

Optionally, the network-side device may indicate an updated sending period of the second-stage synchronization signal in the resource (such as the corresponding MIB, SIB, or other messages) associated with the first-stage synchronization signal and/or the second-stage synchronization signal. The terminal performs detection based on information about the updated sending period of the second-stage synchronization signal. A terminal that has performed access based on the second-stage synchronization signal may receive the adjusted sending period via the resource associated with the second-stage synchronization signal.

Optionally, the updated sending period of the second-stage synchronization signal may alternatively not be notified to the terminal. This can simplify the network configuration, but may lead to more invalid detection by the terminal.

Optionally, the network-side device may also uniformly adjust sending periods of all second-stage synchronization signals. For example, the network-side device may uniformly adjust the sending periods of all the second-stage synchronization signals based on the quantity of users and/or the traffic conditions of the entire network, and may indicate the updated sending period of the second-stage synchronization signal in the resource (such as the corresponding MIB, SIB, and other messages) associated with the first-stage synchronization signal and/or the second-stage synchronization signal. It should be noted that a duration of the sending period may be a duration of one frame.

It should be noted that in the foregoing embodiment, the network-side device adjusts the sending configuration parameter of the second-stage synchronization signal to achieve an objective of network energy saving. Because the second-stage synchronization signal can be reused among different TRP clusters, disabling unused second-stage synchronization signals can reduce interference between the second-stage synchronization signals and improve transmission reliability.

Optionally, the sending configuration parameter may alternatively be sent based on a request of the terminal. In another embodiment of this application, the method further includes:
the terminal sends a first uplink signal to the network-side device, where the first uplink signal is used to request the network-side device to adjust a sending configuration parameter of a second-stage synchronization signal.

Optionally, in another embodiment of this application, after the terminal receives the first indication information sent by the network-side device via the system information associated with the first-stage synchronization signal and/or the second-stage synchronization signal, the method further includes:
the terminal determines a resource position of the second-stage synchronization signal based on the sending configuration parameter, where the resource position includes a time-domain position and/or a frequency-domain position; and
the terminal detects the second-stage synchronization signal based on the resource position of the second-stage synchronization signal.

Further optionally, in another embodiment of this application, a specific implementation of the sending a first uplink signal to the network-side device by the terminal includes:
the terminal sends the first uplink signal to the network-side device based on detected signal quality of a target signal, where
the target signal includes the first-stage synchronization signal; and the signal quality includes RSRP, RSRQ, or an SINR.

Optionally, in a case that the terminal detects that signal quality of all first-stage synchronization signals is less than a first threshold, the first uplink signal is sent to the network-side device. It should be noted that the first threshold may be specified in a protocol, preconfigured, or configured by the network-side device.

Further, the terminal sends the first uplink signal on a PRACH resource associated with a first-stage synchronization signal with highest signal quality.

For example, the network-side device sends four first-stage synchronization signals: a synchronization signal 1, a synchronization signal 2, a synchronization signal 3, and a synchronization signal 4, and the terminal detects that RSRP of the four first-stage synchronization signals is −100 dBm, −120 dBm, −150 dBm, and −102 dBm respectively, but the RSRP of all the four first-stage synchronization signals is less than the first threshold (for example, −80 dBm). In this case, the terminal selects to send the first uplink signal on a PRACH resource associated with the synchronization signal 1 with highest RSRP.

It should be noted that, in this case, the sending configuration parameter of the second-stage synchronization signal is adjusted based on the first-stage synchronization signal. Usually, this applies to a case that the second-stage synchronization signal is not enabled, that is, the terminal actively requests to enable the second-stage synchronization signal in a case that quality of the first-stage synchronization signal is poor. In other words, the second-stage synchronization signal may be dynamically enabled in an on-demand mode, and sent at the request of the terminal.

In a case that the second-stage synchronization signal can be dynamically enabled in the on-demand mode, the network-side device needs to send information (which may include, for example, at least one of A11 to A17) about the second-stage synchronization signal to be enabled to the terminal. For example, the network-side device may send, in the system information associated with the first-stage synchronization signal, the information about the second-stage synchronization signal to be enabled.

Optionally, the first uplink signal includes a second Msg 1 or a signaling request message in a connected state.

It should be noted that the second Msg 1 may be understood as a Msg 1 not used for random access. In other words, in this case, a preamble corresponding to one or more first-stage synchronization signals is defined as a specific preamble (that is, a Msg 1) for triggering the second-stage synchronization signal, and the specific preamble is specified in the system information, for example, fixed as the first or last preamble. When the terminal sends the specific preamble, the network-side device may know that the terminal requests to enable sending of the second-stage synchronization signal.

Optionally, in this case, the first uplink signal may include identification information (for example, an ID) of the first-stage synchronization signal. In other words, the terminal may actively request to enable sending of a second-stage synchronization signal associated with a specific first-stage synchronization signal.

It should be noted that, because the terminal indicates the ID of the first-stage synchronization signal that meets the condition, the network-side device can enable only the second-stage synchronization signal associated with the first-stage synchronization signal, rather than other or all second-stage synchronization signals. This can reduce the interference between the second-stage synchronization signals, increase a success rate of access, and reduce energy consumption of the network-side device.

Further, by using the first uplink signal, the terminal may request the network-side device to send one or more second-stage synchronization signals associated with the selected first-stage synchronization signal, to assist the terminal in downlink signal measurement, where the terminal obtains information about the second-stage synchronization signal via the first-stage synchronization signal and/or the system information corresponding to the first-stage synchronization signal.

Optionally, in another embodiment of this application, the method further includes at least one of the following:

C11. In a case that a first-stage synchronization signal with signal quality greater than or equal to a first threshold is detected, the terminal sends a first Msg 1 or a Msg A for random access on a PRACH resource associated with a first-stage synchronization signal with highest signal quality.

It should be noted that the first Msg 1 is a Msg 1 for random access.

This case may be understood as: if there is a first-stage synchronization signal that can be used for random access, the terminal performs random access via the PRACH resource associated with the first-stage synchronization signal with the highest signal quality.

C12. The terminal sends, based on detected signal quality of the first-stage synchronization signal, a first Msg 1 or a Msg A for random access via a PRACH resource associated with a first target first-stage synchronization signal, where the first target first-stage synchronization signal is a synchronization signal with signal quality greater than or equal to a fourth threshold among the first-stage synchronization signals.

This case may be understood as: if there is a first-stage synchronization signal that can be used for random access, the terminal further selects a PRACH resource associated with a first-stage synchronization signal with signal quality greater than or equal to the fourth threshold to perform random access; or if there are a plurality of first-stage synchronization signals with signal quality greater than or equal to the fourth threshold, the terminal may randomly select one of the plurality of first-stage synchronization signals.

It should be noted that the fourth threshold is specified in a protocol, preconfigured, or configured by the network-side device. The fourth threshold may be the same as or different from the first threshold.

Optionally, in another embodiment of this application, after the terminal sends the first uplink signal, the method further includes at least one of the following:

D11. The terminal detects the second-stage synchronization signal based on the sending configuration parameter, obtains signal quality of the second-stage synchronization signal, and sends a first Msg 1 or a Msg A for random access on a PRACH resource associated with any second-stage synchronization signal with signal quality greater than or equal to a second threshold.

It should be noted that the second threshold may be understood as a lowest threshold for random access based on the second-stage synchronization signal. The second threshold is specified in a protocol, preconfigured, or configured by the network-side device. This case may be understood as: after sending the first uplink signal, the terminal receives the sending configuration parameter, and then the terminal detects the second-stage synchronization signal based on the sending configuration parameter, and randomly selects one of second-stage synchronization signals with signal quality greater than or equal to the second threshold to perform random access.

D12. In a case that signal quality of the second-stage synchronization signal detected by the terminal is less than or equal to a third threshold, the terminal increases transmit power to resend the first uplink signal or send a second uplink signal, where the second uplink signal is used to request to adjust a sending configuration parameter of a second-stage synchronization signal associated with one or more other first-stage synchronization signals, and the other first-stage synchronization signal is a synchronization signal other than the first-stage synchronization signal corresponding to the PRACH resource for sending the first uplink signal.

It should be noted that, the third threshold is a lowest threshold that the terminal considers for detecting the second-stage synchronization signal. The third threshold is specified in a protocol, preconfigured, or configured by the network-side device. For example, the third threshold may be a fixed threshold or a threshold related to the signal quality of the first-stage synchronization signal. This case may be understood as: the terminal does not receive the sending configuration parameter immediately after sending the first uplink signal. In this case, the terminal does not know whether the network-side device sends the second-stage synchronization signal, and the terminal needs to perform detection at a candidate position of the second-stage synchronization signal. If the detected signal quality is greater than the third threshold, it indicates that the second-stage synchronization signal is successfully detected. If the detected signal quality is less than or equal to the third threshold, it indicates that the second-stage synchronization signal is not successfully detected, which means that the network-side device has not received the first uplink signal sent by the terminal. In this case, the terminal may readjust transmit power of the first uplink signal to resend the first uplink signal, or may send the second uplink signal to request to enable the second-stage synchronization signal associated with the other first-stage synchronization signal.

The random access procedure in which the second-stage synchronization signal is dynamically enabled in the on-demand mode mentioned above is described in detail as follows:

A main process includes:

The terminal detects the first-stage synchronization signal based on the sync raster of the first-stage synchronization signal, and selects, based on a detection result of the RSRP, SINR, or RSRQ of the first-stage synchronization signal, a first-stage synchronization signal reaching the fourth threshold, and sends a Msg A or a first Msg 1 (which may be understood as a conventional Msg 1) for random access.

If the terminal detects that the RSRP, SINR, or RSRQ of all the first-stage synchronization signals is lower than the first threshold, the terminal selects a first-stage synchronization signal with the highest RSRP, SINR, or RSRQ, and sends a second Msg 1 on a PRACH resource corresponding to the first-stage synchronization signal, requesting to enable a second-stage synchronization signal associated with this first-stage synchronization signal. Otherwise, the terminal sends the Msg A or the first Msg 1 for random access.

Further, if the network-side device receives the Msg A or the first Msg 1, the network-side device sends a Msg B or a Msg 2, where a beam of the Msg B or the Msg 2 is determined based on the selected first-stage synchronization signal.

If the network-side device receives the second Msg 1, the network-side device sends the first indication information within a specific time window, indicating information about the second-stage synchronization signal to be enabled, for example, at least one of A11 to A17 above; and based on the request of the terminal, the network-side device may enable some or all of the second-stage synchronization signals associated with the corresponding first-stage synchronization signal.

After sending the second Msg 1 requesting to enable the second-stage synchronization signal, the terminal monitors the system information in a corresponding frequency band within a specific time window based on the indication of the first-stage synchronization signal or a protocol configuration to obtain the information about the second-stage synchronization signal.

The terminal detects the second-stage synchronization signal based on the information about the second-stage synchronization signal, selects a second-stage synchronization signal whose RSRP, SINR, or RSRQ reaches the second threshold, and sends the Msg A or the first Msg 1 for random access.

If the terminal does not detect the second-stage synchronization signal (which means that the RSRP, SINR, or RSRQ of the detected second-stage synchronization signal is less than or equal to the third threshold, for example, lower than the signal quality of the first-stage synchronization signal, or lower than the first threshold), it indicates that the network-side device has not received the request for enabling the second-stage synchronization signal. In this case, the terminal gradually increases the transmit power to resend the second Msg 1, or requests to enable a second-stage synchronization signal associated with one or more other first-stage synchronization signals, until the network-side device enables the second-stage synchronization signal.

Further, based on the second-stage synchronization signal enabled by the network-side device, the terminal selects a second-stage synchronization signal to send a Msg A or a first Msg 1 for random access. After receiving the Msg A or the first Msg 1 sent by the terminal, the network-side device sends a Msg B or a Msg 2, where a beam of the Msg B or the Msg 2 is determined based on the second-stage synchronization signal selected by the terminal.

It should be noted that requesting the sending of the second-stage synchronization signal in the on-demand mode can achieve the objective of network energy saving.

Optionally, in a case that the network-side device has sent the second-stage synchronization signal, the terminal may also request to adjust the sending configuration parameter of the second-stage synchronization signal, mainly including at least one of A11 to A17. In another embodiment of this application, the target signal further includes the second-stage synchronization signal.

Further, that the terminal sends the first uplink signal to the network-side device based on detected signal quality of a target signal includes:
in a case that detected signal quality of both the first-stage synchronization signal and the second-stage synchronization signal is less than a detection threshold for random access, the terminal sends the first uplink signal to the network-side device via a resource associated with the first-stage synchronization signal or the second-stage synchronization signal.

It should be noted that if the terminal detects that the signal quality of both the first-stage synchronization signal and the second-stage synchronization signal is less than the detection threshold for random access, it indicates that the signal quality of the existing two-stage synchronization signals is poor. In this case, the terminal may request to adjust the sending configuration parameter of the second-stage synchronization signal to increase a probability of successful random access of the terminal.

Optionally, the first uplink signal includes a second Msg 1 or a signaling request message in a connected state.

Optionally, the first uplink signal includes identification information of the first-stage synchronization signal.

Optionally, the adjusted second-stage synchronization signal includes at least one second-stage synchronization signal associated with the first-stage synchronization signal.

For example, by sending the first uplink signal, the terminal may request the network-side device to increase or decrease the quantity of second-stage synchronization signals or adjust the sending period of the second-stage synchronization signal.

A specific implementation process may be as follows: First, a preamble corresponding to one or more first-stage synchronization signals and/or second-stage synchronization signals is defined as a specific preamble (that is, a second Msg 1) for suggesting/requesting an increase in the quantity of second-stage synchronization signals or a decrease in the sending period of the second-stage synchronization signal (that is, an increase in a sending frequency of the second-stage synchronization signal), and is specified in the system information corresponding to the first-stage synchronization signal and/or the second-stage synchronization signal, for example, fixed as the first or last preamble. When the terminal sends the specific preamble, the network-side device may know that the terminal requests to increase the quantity of second-stage synchronization signals or increase the sending frequency of the second-stage synchronization signal.

For example, when the terminal detects that the RSRP, SINR, or RSRQ of the currently broadcast first-stage synchronization signal and second-stage synchronization signal is lower than the detection threshold for random access, the terminal may send the specific preamble (that is, the second Msg 1) to suggest/request that the network-side device should increase the quantity of second-stage synchronization signals or increase the sending frequency of the second-stage synchronization signal.

Optionally, in another embodiment of this application, a switching implementation of two-stage synchronization signals is also provided and mainly includes: in a case that random access based on a first target synchronization signal fails, switching to random access based on a second target synchronization signal, where each of the first target synchronization signal and the second target synchronization signal is one of the first-stage synchronization signal and the second-stage synchronization signal, and the first target synchronization signal is different from the second target synchronization signal.

In other words, after the terminal fails to perform random access based on a synchronization signal at one stage, the terminal may switch to using the synchronization signal at the other stage for random access, to increase a success rate of random access.

Optionally, the switching to random access based on a second target synchronization signal in a case that random access based on a first target synchronization signal fails includes:
in a case that random access based on the first target synchronization signal fails, the terminal switches, based on target information, to random access based on the second target synchronization signal.

The target information includes one of the following:

E11. A switching indication sent by the network-side device.

It should be noted that, this case means that the switching between random access based on the first-stage synchronization signal and random access based on the second-stage synchronization signal may be explicitly scheduled by the network-side device. For example, the network-side device may enable random access switching via system information, or the network-side device dynamically indicates in a Msg 4 that the terminal is to switch the synchronization signal for random access.

For example, in a case of switching between two-stage synchronization signals for random access, the network-side device may indicate the switching via system information. Optionally, the network-side device may further specify an ID of the synchronization signal at the other stage or a preamble ID in the system information.

For example, when a collision fails to be resolved, the network-side device may use a Msg 4 to indicate a terminal that succeeds in random access, and may use a specific information bit to instruct a terminal that fails in the collision resolution to perform four-step or two-step random access again based on either the first-stage synchronization signal or the second-stage synchronization signal.

Further optionally, after receiving the Msg 4, the terminal that fails in the collision resolution may select an earliest second-stage synchronization signal in time domain for measurement, and select a second-stage synchronization signal for four-step or two-step random access.

E12. A relationship between the number of failures of random access and a fifth threshold.

It should be noted that the fifth threshold is specified in a protocol, preconfigured, or configured by the network-side device. This case means that the switching between random access based on the first-stage synchronization signal and random access based on the second-stage synchronization signal can also be triggered based on the fifth threshold according to a fixed procedure. The fifth threshold refers to the number of access failures, which is specified in a protocol, preconfigured, or configured by the network-side device. For example, when the terminal uses the first-stage synchronization signal for random access, the terminal automatically switches to using the second-stage synchronization signal for random access after the number of failures exceeds the fifth threshold.

It should be noted that random access based on the first-stage synchronization signal mentioned above refers to random access via the resource associated with the first-stage synchronization signal, and that random access based on the second-stage synchronization signal refers to random access via the resource associated with the second-stage synchronization signal.

Further, based on the relationship between the number of failures of random access and the fifth threshold, the following switching implementation processes are provided and described in detail below.

### Implementation Process 1

Specifically, that the terminal switches, based on target information, to random access based on the second target synchronization signal includes:
in a case that random access based on the first-stage synchronization signal fails, the terminal switches to random access based on the second-stage synchronization signal; and
in a case that random access based on the second-stage synchronization signal fails, if the number of failures of random access based on both the first-stage synchronization signal and the second-stage synchronization signal is less than or equal to the fifth threshold, the terminal switches to random access based on the first-stage synchronization signal.

It should be noted that in this case, a failure of random access based on the first-stage synchronization signal and the second-stage synchronization signal is considered as one random access failure. When the number of failures of the two-stage synchronization signals is less than or equal to the fifth threshold, the switching may be continued by using the first-stage synchronization signal for random access, and when the number of failures of the two-stage synchronization signals is greater than the fifth threshold, it is considered that random access fails.

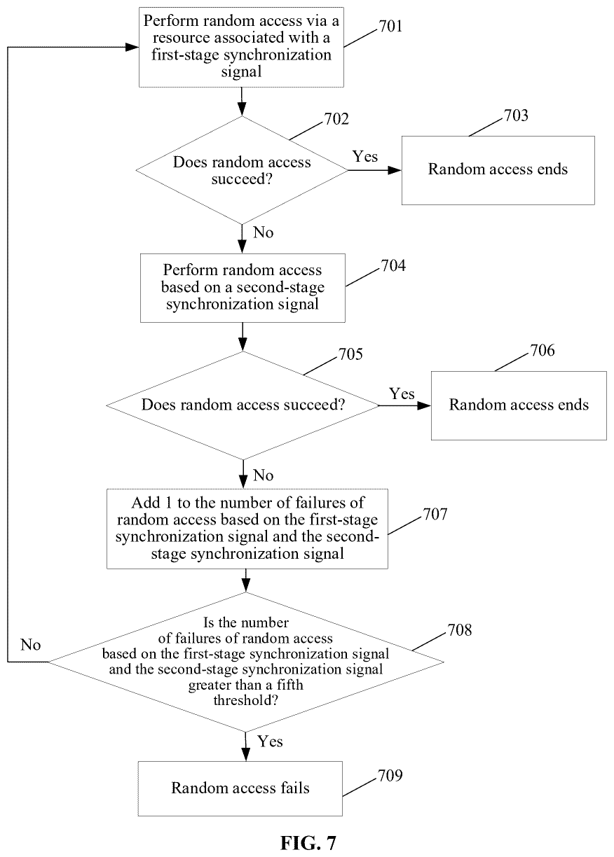

Specifically, as shown in FIG. 7, a main process includes the following steps.

Step 701: The terminal performs random access based on a first-stage synchronization signal.

Step 702: Determine whether random access succeeds, and if random access succeeds, perform step 703, or if random access fails, perform step 704.

Step 703: Random access ends.

Step 704: The terminal performs random access based on a second-stage synchronization signal.

Step 705: Determine whether random access succeeds, and if random access succeeds, perform step 706, or if random access fails, perform step 707.

Step 706: Random access ends.

Step 707: Add 1 to the number of failures of random access based on the first-stage synchronization signal and the second-stage synchronization signal.

Step 708: Determine whether the number of failures of random access based on the first-stage synchronization signal and the second-stage synchronization signal is greater than the fifth threshold, and if the number of failures is greater than the fifth threshold, perform step 709, or else, go to step 701 to continue execution.

Step 709: Random access fails.

It should be noted that this random access switching procedure may be used as a default random access switching procedure.

This case may be understood as: although the terminal fails to perform random access based on the first-stage synchronization signal, because there are a large quantity of second-stage synchronization signals, and beam directions are more finely divided, the terminal can switch to the second-stage synchronization signal to perform a RACH procedure, and a plurality of terminals can detect and select synchronization signals again, which can improve the reliability and success rate of random access. If access of the terminal fails due to a Msg 4 collision resolution failure, switching to perform random access process based on the second-stage synchronization signal can avoid a random backoff process and reduce occurrence of contention.

### Implementation Process 2

Specifically, that the terminal switches, based on target information, to random access based on the second target synchronization signal in a case that random access based on the first target synchronization signal fails includes:
in a case that random access based on the first-stage synchronization signal fails, if the number of failures of random access based on the first-stage synchronization signal is greater than the fifth threshold, the terminal switches to random access based on the second-stage synchronization signal.

This case may be understood as: first performing random access based on the first-stage synchronization signal, and in a case that the number of failures of random access based on the first-stage synchronization signal is greater than the fifth threshold, switching to random access based on the second-stage synchronization signal.

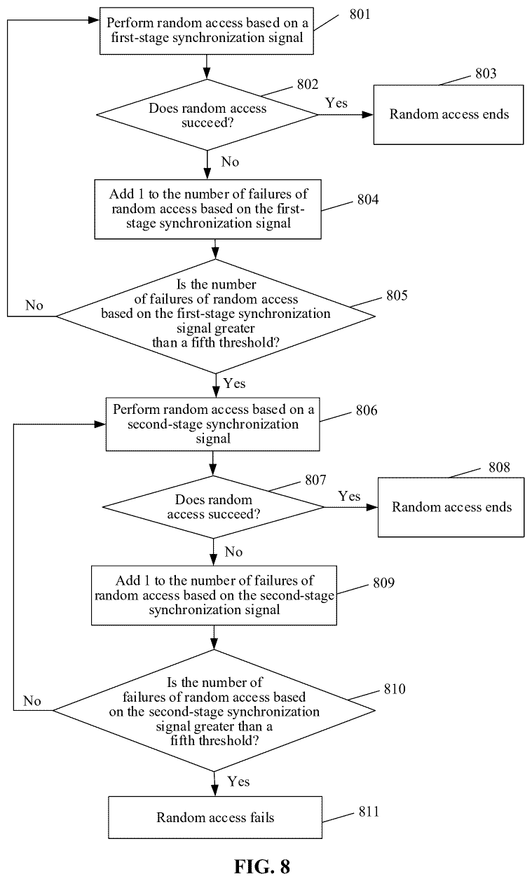

Specifically, as shown in FIG. 8, a main process includes the following steps.

Step 801: Perform random access based on a first-stage synchronization signal.

Step 802: Determine whether random access succeeds, and if random access succeeds, perform step 803, or if random access fails, perform step 804.

Step 803: Random access ends.

Step 804: Add 1 to the number of failures of random access based on the first-stage synchronization signal.

Step 805: Determine whether the number of failures of random access based on the first-stage synchronization signal is greater than the fifth threshold, and if the number of failures is greater than the fifth threshold, perform step 806, or else, go to step 801 to continue execution.

Step 806: Perform random access based on a second-stage synchronization signal.

Step 807: Determine whether random access succeeds, and if random access succeeds, perform step 808, or if random access fails, perform step 809.

Step 808: Random access ends.

Step 809: Add 1 to the number of failures of random access based on the second-stage synchronization signal.

Step 810: Determine whether the number of failures of random access based on the second-stage synchronization signal is greater than the fifth threshold, and if the number of failures is greater than the fifth threshold, perform step 811, or else, go to step 806 to continue execution.

Step 811: Random access fails.

Herein, it should be noted that values of the fifth threshold for determining the number of failures of random access based on the second-stage synchronization signal and the fifth threshold for determining the number of failures of random access based on the first-stage synchronization signal may be the same or different.

Optionally, another embodiment of this application further provides a method for forbidding the terminal to perform random access on a PRACH resource associated with a first-stage synchronization signal, specifically as follows:

The terminal receives second indication information sent by the network-side device, where the second indication information is used to instruct the terminal to receive a second-stage synchronization signal associated with a second target first-stage synchronization signal, and forbid the terminal to perform random access on a PRACH resource associated with the second target first-stage synchronization signal.

Optionally, in a case that it is determined that a quantity of terminals performing access based on the second target first-stage synchronization signal is greater than or equal to a preset value, the network-side device sends the second indication information to the terminal. After receiving the second indication information, the terminal sends a random access message via a PRACH resource associated with the second-stage synchronization signal.

It should be noted that, the quantity of terminals performing access based on the first-stage synchronization signal being greater than or equal to the preset value may be understood as overload of the first-stage synchronization signal. In this embodiment, if load of a first-stage synchronization signal is excessively high, the network-side device may send second indication information on a resource associated with the first-stage synchronization signal, indicating that the terminal cannot use the resource associated with the first-stage synchronization signal for random access, but only receives a second-stage synchronization signal associated with the first-stage synchronization signal, and uses the second-stage synchronization signal for random access.

In other words, after receiving the second indication information, the terminal does not send a Msg 1, a Msg 3, or a Msg A on the resource associated with the first-stage synchronization signal. The terminal continues to detect all associated second-stage synchronization signals only after detecting the first-stage synchronization signal, and sends a corresponding Msg 1, Msg 3, or Msg A via the resource associated with the second-stage synchronization signal. After receiving the Msg 1, Msg 3, or Msg A sent by the terminal, the network-side device sends a Msg 2, a Msg 4, or a Msg B, where a beam of the Msg 2, the Msg 4, or the Msg B is determined based on the second-stage synchronization signal selected by the terminal.

It should be noted that, in this embodiment, load pressure on the first-stage synchronization signal can be alleviated by extending the second-stage synchronization signal, thereby increasing a quantity of users accessing the network; energy consumption of the terminal is reduced by decreasing the number of times of sending a Msg 1, a Msg 3, or a Msg A by the terminal; and the success rate of access and data transmission rate of the terminal are increased by obtaining a more accurate beam direction and higher signal strength via the second-stage synchronization signal.

It should be noted that, for an architecture with two-stage mutually associated synchronization signals, the foregoing embodiment of this application proposes a mechanism for adjusting the quantity of second-stage synchronization signals to be sent, the period, or a switch, or allowing the terminal to suggest/request an adjustment to the quantity of second-stage synchronization signals to be sent, the period, or a dynamic switch. For example, when the RSRP, SINR, or RSRQ of the first-stage synchronization signal is lower than the threshold, the terminal sends an uplink signal requesting to enable the second-stage synchronization signal, and performs access based on the second-stage synchronization signal. After the terminal fails to perform random access based on a synchronization signal at one stage, the terminal may switch to using the synchronization signal at the other stage for random access, either based on scheduling information from the network-side device or based on a fixed procedure, with thresholds defined in a protocol or preconfigured by the network. When the load of the first-stage synchronization signal is excessively high, the network-side device may keep all the second-stage synchronization signals enabled, and send an indication via the resource associated with the first-stage synchronization signal, to indicate that the terminal is forbidden to perform random access via the PRACH resource associated with the first-stage synchronization signal and can only perform random access via the PRACH resource associated with the second-stage synchronization signal.

It should be noted that at least one embodiment of this application can achieve the following beneficial effects:

1. The design of the mechanism for dynamically adjusting the quantity of second-stage synchronization signals to be sent, the period, or the switch, or allowing the terminal to suggest/request an adjustment to the quantity of second-stage synchronization signals, the period, or the dynamic switch can achieve network-side energy saving, reduce interference between second-stage synchronization signals, and improve the success rate of access and reliability of the terminal.

2. When the terminal fails to perform random access based on the first-stage synchronization signal, the terminal can switch to the random access procedure based on the second-stage synchronization signal, and a plurality of terminals can detect and select synchronization signals again. Because there are a large quantity of second-stage synchronization signals, and the beam directions are more finely divided, the reliability and success rate of random access can be improved. If access of the terminal fails due to a Msg 4 collision resolution failure, switching to random access based on the second-stage synchronization signal can avoid a random backoff process and reduce occurrence of contention.

3. When the load of the first-stage synchronization signal is high, the network instructs the terminal to perform random access via the resource associated with the first-stage synchronization signal. This can alleviate the load pressure on the first-stage synchronization signal and increase the quantity of users accessing the network. Moreover, the terminal obtains a more accurate beam direction and higher signal strength via the second-stage synchronization signal, thereby increasing the success rate of access and data transmission rate of the terminal.

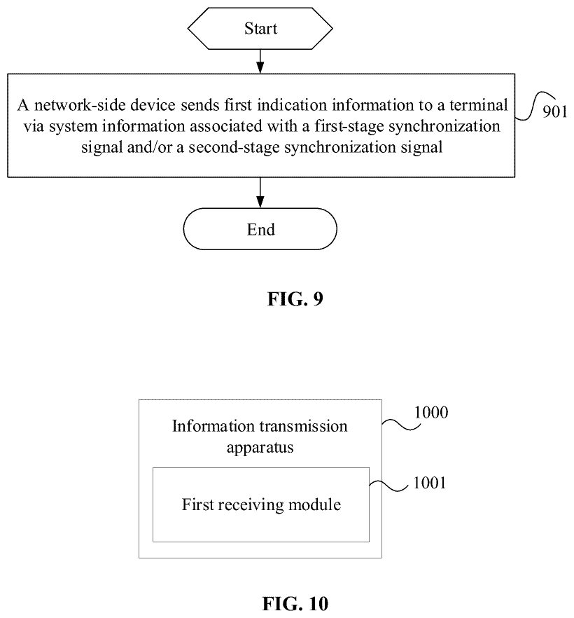

Corresponding to the implementation on the terminal side, as shown in FIG. 9, an embodiment of this application provides an information transmission method, including:

Step 901: A network-side device sends first indication information to a terminal via system information associated with a first-stage synchronization signal and/or a second-stage synchronization signal, where the first indication information is used to indicate an adjusted sending configuration parameter of the second-stage synchronization signal, where
the sending configuration parameter includes at least one of the following:
a synchronization raster;
a frequency-domain position;
a time-domain position;
a time-domain offset and/or a frequency-domain offset of the second-stage synchronization signal relative to the first-stage synchronization signal;
a mapping relationship between an index set of the first-stage synchronization signal and an index set of the second-stage synchronization signal;
a quantity of second-stage synchronization signals;
a sending period; and
a transmission state, where the transmission state includes: sending enabled or sending disabled.

Optionally, that a network-side device sends first indication information to a terminal includes:
the network-side device sends the first indication information to the terminal based on an access status of the terminal.

Optionally, before the network-side device sends the first indication information to the terminal, the method further includes:
the network-side device receives a first uplink signal sent by the terminal, where the first uplink signal is used to request the network-side device to adjust a sending configuration parameter of a second-stage synchronization signal.

Optionally, the first uplink signal includes a second Msg 1 or a signaling request message in a connected state.

Optionally, the first uplink signal includes identification information of the first-stage synchronization signal.

Optionally, the adjusted second-stage synchronization signal includes at least one second-stage synchronization signal associated with the first-stage synchronization signal.

Optionally, after the network-side device receives the first uplink signal sent by the terminal, the method further includes:
the network-side device receives a second uplink signal sent by the terminal, where the second uplink signal is used to request to adjust a sending configuration parameter of a second-stage synchronization signal associated with one or more other first-stage synchronization signals, and the other first-stage synchronization signal is a synchronization signal other than a first-stage synchronization signal corresponding to a PRACH resource for sending the first uplink signal.

Optionally, the method further includes:
in a case that it is determined that a quantity of terminals performing access based on a second target first-stage synchronization signal is greater than or equal to a preset value, the network-side device sends second indication information to the terminal, where the second indication information is used to instruct the terminal to receive a second-stage synchronization signal associated with the second target first-stage synchronization signal, and forbid the terminal to perform random access on a PRACH resource associated with the second target first-stage synchronization signal.

It should be noted that all descriptions about the network-side device in the foregoing embodiment are applicable to the embodiment of the information transmission method applied to the network-side device, with the same technical effect achieved. Details are not described herein again.

The information transmission method provided in the embodiments of this application may be performed by an information transmission apparatus. An information transmission apparatus provided in the embodiments of this application is described by assuming that the information transmission method is performed by the information transmission apparatus in the embodiments of this application.

As shown in FIG. 10, an information transmission apparatus 1000 in an embodiment of this application is applied to a terminal and includes:
a first receiving module 1001, configured to receive first indication information sent by a network-side device via system information associated with a first-stage synchronization signal and/or a second-stage synchronization signal, where the first indication information is used to indicate an adjusted sending configuration parameter of the second-stage synchronization signal, where
the sending configuration parameter includes at least one of the following:
a synchronization raster;
a frequency-domain position;
a time-domain position;
a time-domain offset and/or a frequency-domain offset of the second-stage synchronization signal relative to the first-stage synchronization signal;
a mapping relationship between an index set of the first-stage synchronization signal and an index set of the second-stage synchronization signal;
a quantity of second-stage synchronization signals;
a sending period; and
a transmission state, where the transmission state includes: sending enabled or sending disabled.

Optionally, the apparatus further includes:
a second sending module, configured to send a first uplink signal to the network-side device, where the first uplink signal is used to request the network-side device to adjust a sending configuration parameter of a second-stage synchronization signal.

Optionally, after the first receiving module 1001 receives the first indication information sent by the network-side device via the system information associated with the first-stage synchronization signal and/or the second-stage synchronization signal, the apparatus further includes:
a determining module, configured to determine a resource position of the second-stage synchronization signal based on the sending configuration parameter, where the resource position includes a time-domain position and/or a frequency-domain position; and
a detection module, configured to detect the second-stage synchronization signal based on the resource position of the second-stage synchronization signal.

Optionally, the second sending module is configured to:
send the first uplink signal to the network-side device based on detected signal quality of a target signal, where
the target signal includes the first-stage synchronization signal; and the signal quality includes reference signal received power RSRP, reference signal received quality RSRQ, or a signal to interference plus noise ratio SINR.

Optionally, the second sending module is configured to:
in a case that it is detected that signal quality of all first-stage synchronization signals is less than a first threshold, send the first uplink signal to the network-side device.

Optionally, the second sending module is configured to:
send the first uplink signal on a physical random access channel PRACH resource associated with a first-stage synchronization signal with highest signal quality.

Optionally, the apparatus further includes:
a third sending module, configured to: detect the second-stage synchronization signal based on the sending configuration parameter, obtain signal quality of the second-stage synchronization signal, and send a first Msg 1 or a Msg A for random access on a PRACH resource associated with any second-stage synchronization signal with signal quality greater than or equal to a second threshold; or
a fourth sending module, configured to: in a case that signal quality of the second-stage synchronization signal detected by the terminal is less than or equal to a third threshold, increase transmit power to resend the first uplink signal or send a second uplink signal, where the second uplink signal is used to request to adjust a sending configuration parameter of a second-stage synchronization signal associated with one or more other first-stage synchronization signals, and the other first-stage synchronization signal is a synchronization signal other than the first-stage synchronization signal corresponding to the PRACH resource for sending the first uplink signal.

Optionally, the target signal further includes the second-stage synchronization signal.

Optionally, the second sending module is configured to:
in a case that detected signal quality of both the first-stage synchronization signal and the second-stage synchronization signal is less than a detection threshold for random access, send the first uplink signal to the network-side device via a resource associated with the first-stage synchronization signal or the second-stage synchronization signal.

Optionally, the first uplink signal includes a second Msg 1 or a signaling request message in a connected state.

Optionally, the first uplink signal includes identification information of the first-stage synchronization signal.

Optionally, the adjusted second-stage synchronization signal includes at least one second-stage synchronization signal associated with the first-stage synchronization signal.

Optionally, the apparatus further includes at least one of the following:
a fifth sending module, configured to: in a case that a first-stage synchronization signal with signal quality greater than or equal to a first threshold is detected, send a first Msg 1 or a Msg A for random access on a PRACH resource associated with a first-stage synchronization signal with highest signal quality; and
a sixth sending module, configured to send, based on detected signal quality of the first-stage synchronization signal, a first Msg 1 or a Msg A for random access via a PRACH resource associated with a first target first-stage synchronization signal, where the first target first-stage synchronization signal is a synchronization signal with signal quality greater than or equal to a fourth threshold among the first-stage synchronization signals.

Optionally, the apparatus further includes:
a switching module, configured to: in a case that random access based on a first target synchronization signal fails, switch to random access based on a second target synchronization signal, where
each of the first target synchronization signal and the second target synchronization signal is one of the first-stage synchronization signal and the second-stage synchronization signal, and the first target synchronization signal is different from the second target synchronization signal.

Optionally, the switching module includes:
a first switching unit, configured to: in a case that random access based on the first target synchronization signal fails, switch, based on target information, to random access based on the second target synchronization signal, where
the target information includes one of the following:
a switching indication sent by the network-side device; and
a relationship between the number of failures of random access and a fifth threshold.

Optionally, in a case that the target information is the relationship between the number of failures of random access and the fifth threshold, in a case that random access based on the first target synchronization signal fails, the first switching unit is configured to:
in a case that random access based on the first-stage synchronization signal fails, switch to random access based on the second-stage synchronization signal; and
in a case that random access based on the second-stage synchronization signal fails, if the number of failures of random access based on both the first-stage synchronization signal and the second-stage synchronization signal is less than or equal to the fifth threshold, switch to random access based on the first-stage synchronization signal.

Optionally, in a case that the target information is the relationship between the number of failures of random access and the fifth threshold, in a case that random access based on the first target synchronization signal fails, the first switching unit is configured to:
in a case that random access based on the first-stage synchronization signal fails, if the number of failures of random access based on the first-stage synchronization signal is greater than the fifth threshold, switch to random access based on the second-stage synchronization signal.

Optionally, the apparatus further includes:
a second receiving module, configured to receive second indication information sent by the network-side device, where the second indication information is used to instruct the terminal to receive a second-stage synchronization signal associated with a second target first-stage synchronization signal, and forbid the terminal to perform random access on a PRACH resource associated with the second target first-stage synchronization signal.

Optionally, the apparatus further includes:
a seventh sending module, configured to send a random access message via a PRACH resource associated with the second-stage synchronization signal.

It should be noted that this apparatus embodiment corresponds to the foregoing method. All implementations of the foregoing method embodiment are applicable to this apparatus embodiment, with the same technical effect achieved.

The information transmission apparatus in this embodiment of this application may be an electronic device, for example, an electronic device with an operating system, or may be a component in an electronic device, for example, an integrated circuit or a chip. The electronic device may be a terminal, or may be other devices than a terminal. For example, the terminal may include but is not limited to the foregoing illustrated type of the terminal 11. The other devices may be a server, a network attached storage (NAS), and the like. This is not specifically limited in this embodiment of this application.

The information transmission apparatus provided in this embodiment of this application can implement each process implemented by the method embodiment in FIG. 6, with the same technical effect achieved. To avoid repetition, details are not described herein again.

An embodiment of this application further provides a terminal, including a processor and a communication interface. The communication interface is configured to receive first indication information sent by a network-side device via system information associated with a first-stage synchronization signal and/or a second-stage synchronization signal, where the first indication information is used to indicate an adjusted sending configuration parameter of the second-stage synchronization signal, where
the sending configuration parameter includes at least one of the following:
a synchronization raster;
a frequency-domain position;
a time-domain position;
a time-domain offset and/or a frequency-domain offset of the second-stage synchronization signal relative to the first-stage synchronization signal;
a mapping relationship between an index set of the first-stage synchronization signal and an index set of the second-stage synchronization signal;
a quantity of second-stage synchronization signals;
a sending period; and
a transmission state, where the transmission state includes: sending enabled or sending disabled.

Optionally, the communication interface is further configured to:
send a first uplink signal to the network-side device, where the first uplink signal is used to request the network-side device to adjust a sending configuration parameter of a second-stage synchronization signal.

Optionally, the processor is configured to:
determine a resource position of the second-stage synchronization signal based on the sending configuration parameter, where the resource position includes a time-domain position and/or a frequency-domain position; and
detect the second-stage synchronization signal based on the resource position of the second-stage synchronization signal.

Optionally, the communication interface is configured to:
send the first uplink signal to the network-side device based on detected signal quality of a target signal, where
the target signal includes the first-stage synchronization signal; and the signal quality includes reference signal received power RSRP, reference signal received quality RSRQ, or a signal to interference plus noise ratio SINR.

Optionally, the communication interface is configured to:
in a case that it is detected that signal quality of all first-stage synchronization signals is less than a first threshold, send the first uplink signal to the network-side device.

Optionally, the communication interface is configured to:
send the first uplink signal on a physical random access channel PRACH resource associated with a first-stage synchronization signal with highest signal quality.

Optionally, the communication interface is further configured to:
detect the second-stage synchronization signal based on the sending configuration parameter, obtain signal quality of the second-stage synchronization signal, and send a first Msg 1 or a Msg A for random access on a PRACH resource associated with any second-stage synchronization signal with signal quality greater than or equal to a second threshold; or
in a case that signal quality of the second-stage synchronization signal detected by the terminal is less than or equal to a third threshold, increase transmit power to resend the first uplink signal or send a second uplink signal, where the second uplink signal is used to request to adjust a sending configuration parameter of a second-stage synchronization signal associated with one or more other first-stage synchronization signals, and the other first-stage synchronization signal is a synchronization signal other than the first-stage synchronization signal corresponding to the PRACH resource for sending the first uplink signal.

Optionally, the target signal further includes the second-stage synchronization signal.

Optionally, the communication interface is configured to:
in a case that detected signal quality of both the first-stage synchronization signal and the second-stage synchronization signal is less than a detection threshold for random access, send the first uplink signal to the network-side device via a resource associated with the first-stage synchronization signal or the second-stage synchronization signal.

Optionally, the first uplink signal includes a second Msg 1 or a signaling request message in a connected state.

Optionally, the first uplink signal includes identification information of the first-stage synchronization signal.

Optionally, the adjusted second-stage synchronization signal includes at least one second-stage synchronization signal associated with the first-stage synchronization signal.

Optionally, the communication interface is further configured to implement at least one of the following:
in a case that a first-stage synchronization signal with signal quality greater than or equal to a first threshold is detected, sending a first Msg 1 or a Msg A for random access on a PRACH resource associated with a first-stage synchronization signal with highest signal quality; and
sending, based on detected signal quality of the first-stage synchronization signal, a first Msg 1 or a Msg A for random access via a PRACH resource associated with a first target first-stage synchronization signal, where the first target first-stage synchronization signal is a synchronization signal with signal quality greater than or equal to a fourth threshold among the first-stage synchronization signals.

Optionally, the processor is further configured to:
in a case that random access based on a first target synchronization signal fails, switch to random access based on a second target synchronization signal, where
each of the first target synchronization signal and the second target synchronization signal is one of the first-stage synchronization signal and the second-stage synchronization signal, and the first target synchronization signal is different from the second target synchronization signal.

Optionally, the processor is configured to:
in a case that random access based on the first target synchronization signal fails, switch, based on target information, to random access based on the second target synchronization signal, where
the target information includes one of the following:
a switching indication sent by the network-side device; and
a relationship between the number of failures of random access and a fifth threshold.

Optionally, in a case that the target information is the relationship between the number of failures of random access and the fifth threshold, in a case that random access based on the first target synchronization signal fails, the processor is configured to:
in a case that random access based on the first-stage synchronization signal fails, switch to random access based on the second-stage synchronization signal; and
in a case that random access based on the second-stage synchronization signal fails, if the number of failures of random access based on both the first-stage synchronization signal and the second-stage synchronization signal is less than or equal to the fifth threshold, switch to random access based on the first-stage synchronization signal.

Optionally, in a case that the target information is the relationship between the number of failures of random access and the fifth threshold, in a case that random access based on the first target synchronization signal fails, the processor is configured to:
in a case that random access based on the first-stage synchronization signal fails, if the number of failures of random access based on the first-stage synchronization signal is greater than the fifth threshold, switch to random access based on the second-stage synchronization signal.

Optionally, the communication interface is further configured to:
receive second indication information sent by the network-side device, where the second indication information is used to instruct the terminal to receive a second-stage synchronization signal associated with a second target first-stage synchronization signal, and forbid the terminal to perform random access on a PRACH resource associated with the second target first-stage synchronization signal.

Optionally, the communication interface is further configured to:
send a random access message via a PRACH resource associated with the second-stage synchronization signal.

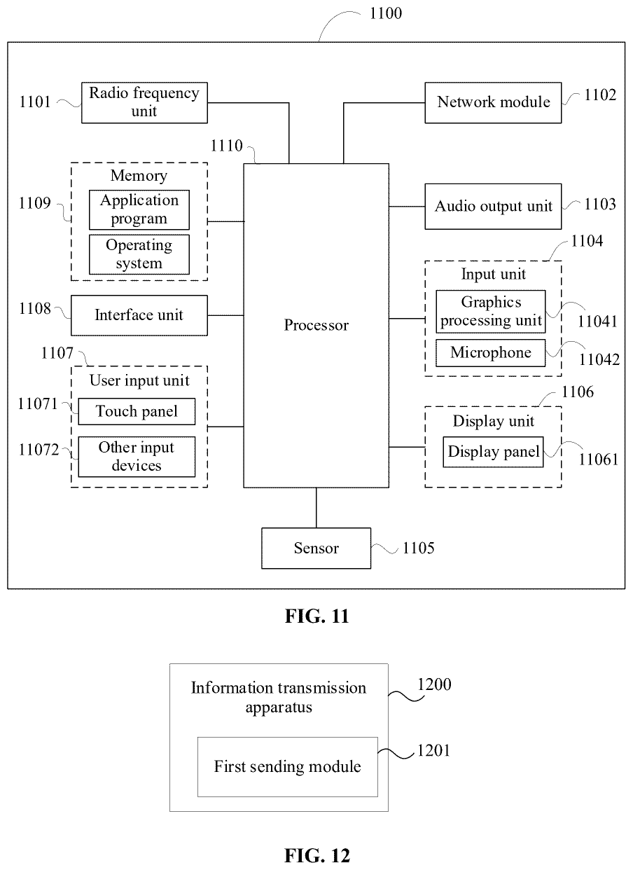

The terminal embodiment corresponds to the foregoing terminal-side method embodiment, and each implementation process and implementation of the foregoing method embodiment can be applied to the terminal embodiment, with the same technical effect achieved. Specifically, FIG. 11 is a schematic diagram of a hardware structure of a terminal for implementing an embodiment of this application.

The terminal 1100 includes but is not limited to at least some components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

A person skilled in the art may understand that the terminal 1100 may further include a power supply (for example, a battery) supplying power to all components. The power supply may be logically connected to the processor 1110 through a power management system. In this way, functions such as charge management, discharge management, and power consumption management are implemented by using the power management system. The terminal structure shown in FIG. 11 does not constitute a limitation on the terminal. The terminal may include more or fewer components than those shown in the figure, or some components are combined, or component arrangements are different. Details are not described herein again.

It should be understood that, in this embodiment of this application, the input unit 1104 may include a graphics processing unit (GPU) 11041 and a microphone 11042. The graphics processing unit 11041 processes image data of a still picture or video obtained by an image capture apparatus (such as a camera) in a video capture mode or an image capture mode. The display unit 1106 may include a display panel 11061, and the display panel 11061 may be configured in a form of a liquid crystal display, an organic light-emitting diode, or the like. The user input unit 1107 includes at least one of a touch panel 11071 and other input devices 11072. The touch panel 11071 is also referred to as a touchscreen. The touch panel 11071 may include two parts: a touch detection apparatus and a touch controller. The other input devices 11072 may include but are not limited to a physical keyboard, a function button (such as a volume control button or a power button), a trackball, a mouse, and a joystick. Details are not described herein again.

In this embodiment of this application, after receiving downlink data from an access network device, the radio frequency unit 1101 may transmit the downlink data to the processor 1110 for processing. In addition, the radio frequency unit 1101 may send uplink data to the network-side device. Usually, the radio frequency unit 1101 includes but is not limited to an antenna, an amplifier, a transceiver, a coupler, a low noise amplifier, a duplexer, and the like.

The memory 1109 may be configured to store software programs or instructions and various data. The memory 1109 may primarily include a first storage area for storing programs or instructions and a second storage area for storing data. The first storage area may store an operating system, an application program or instructions required by at least one function (such as an audio play function and an image play function), and the like. In addition, the memory 1109 may include a volatile memory or a non-volatile memory, or the memory 1109 may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DRRAM). The memory 1109 in this embodiment of this application includes but is not limited to these and any other suitable types of memories.

The processor 1110 may include one or more processing units. Optionally, the processor 1110 integrates an application processor and a modem processor. The application processor mainly processes operations related to the operating system, a user interface, an application program, and the like. The modem processor mainly processes a wireless communication signal. For example, the modem processor is a baseband processor. It may be understood that the modem processor may alternatively be not integrated in the processor 1110.

The radio frequency unit 1101 is configured to:
receive first indication information sent by a network-side device via system information associated with a first-stage synchronization signal and/or a second-stage synchronization signal, where the first indication information is used to indicate an adjusted sending configuration parameter of the second-stage synchronization signal, where
the sending configuration parameter includes at least one of the following:
a synchronization raster;
a frequency-domain position;
a time-domain position;
a time-domain offset and/or a frequency-domain offset of the second-stage synchronization signal relative to the first-stage synchronization signal;
a mapping relationship between an index set of the first-stage synchronization signal and an index set of the second-stage synchronization signal;
a quantity of second-stage synchronization signals;
a sending period; and
a transmission state, where the transmission state includes: sending enabled or sending disabled.

Optionally, the radio frequency unit 1101 is further configured to:
send a first uplink signal to the network-side device, where the first uplink signal is used to request the network-side device to adjust a sending configuration parameter of a second-stage synchronization signal.

Optionally, the processor 1110 is configured to:
determine a resource position of the second-stage synchronization signal based on the sending configuration parameter, where the resource position includes a time-domain position and/or a frequency-domain position; and
detect the second-stage synchronization signal based on the resource position of the second-stage synchronization signal.

Optionally, the radio frequency unit 1101 is configured to:
send the first uplink signal to the network-side device based on detected signal quality of a target signal, where
the target signal includes the first-stage synchronization signal; and the signal quality includes reference signal received power RSRP, reference signal received quality RSRQ, or a signal to interference plus noise ratio SINR.

Optionally, the radio frequency unit 1101 is configured to:
in a case that it is detected that signal quality of all first-stage synchronization signals is less than a first threshold, send the first uplink signal to the network-side device.

Optionally, the radio frequency unit 1101 is configured to:
send the first uplink signal on a physical random access channel PRACH resource associated with a first-stage synchronization signal with highest signal quality.

Optionally, the radio frequency unit 1101 is further configured to:
detect the second-stage synchronization signal based on the sending configuration parameter, obtain signal quality of the second-stage synchronization signal, and send a first Msg 1 or a Msg A for random access on a PRACH resource associated with any second-stage synchronization signal with signal quality greater than or equal to a second threshold; or
in a case that signal quality of the second-stage synchronization signal detected by the terminal is less than or equal to a third threshold, increase transmit power to resend the first uplink signal or send a second uplink signal, where the second uplink signal is used to request to adjust a sending configuration parameter of a second-stage synchronization signal associated with one or more other first-stage synchronization signals, and the other first-stage synchronization signal is a synchronization signal other than the first-stage synchronization signal corresponding to the PRACH resource for sending the first uplink signal.

Optionally, the target signal further includes the second-stage synchronization signal.

Optionally, the radio frequency unit 1101 is configured to:
in a case that detected signal quality of both the first-stage synchronization signal and the second-stage synchronization signal is less than a detection threshold for random access, send the first uplink signal to the network-side device via a resource associated with the first-stage synchronization signal or the second-stage synchronization signal.

Optionally, the first uplink signal includes a second Msg 1 or a signaling request message in a connected state.

Optionally, the first uplink signal includes identification information of the first-stage synchronization signal.

Optionally, the adjusted second-stage synchronization signal includes at least one second-stage synchronization signal associated with the first-stage synchronization signal.

Optionally, the radio frequency unit 1101 is further configured to implement at least one of the following:
in a case that a first-stage synchronization signal with signal quality greater than or equal to a first threshold is detected, sending a first Msg 1 or a Msg A for random access on a PRACH resource associated with a first-stage synchronization signal with highest signal quality; and
sending, based on detected signal quality of the first-stage synchronization signal, a first Msg 1 or a Msg A for random access via a PRACH resource associated with a first target first-stage synchronization signal, where the first target first-stage synchronization signal is a synchronization signal with signal quality greater than or equal to a fourth threshold among the first-stage synchronization signals.

Optionally, the processor 1110 is further configured to:
in a case that random access based on a first target synchronization signal fails, switch to random access based on a second target synchronization signal, where
each of the first target synchronization signal and the second target synchronization signal is one of the first-stage synchronization signal and the second-stage synchronization signal, and the first target synchronization signal is different from the second target synchronization signal.

Optionally, the processor 1110 is further configured to:
in a case that random access based on the first target synchronization signal fails, switch, based on target information, to random access based on the second target synchronization signal, where
the target information includes one of the following:
a switching indication sent by the network-side device; and
a relationship between the number of failures of random access and a fifth threshold.

Optionally, in a case that the target information is the relationship between the number of failures of random access and the fifth threshold, in a case that random access based on the first target synchronization signal fails, the processor is configured to:
in a case that random access based on the first-stage synchronization signal fails, switch to random access based on the second-stage synchronization signal; and
in a case that random access based on the second-stage synchronization signal fails, if the number of failures of random access based on both the first-stage synchronization signal and the second-stage synchronization signal is less than or equal to the fifth threshold, switch to random access based on the first-stage synchronization signal.

Optionally, in a case that the target information is the relationship between the number of failures of random access and the fifth threshold, in a case that random access based on the first target synchronization signal fails, the processor is configured to:
in a case that random access based on the first-stage synchronization signal fails, if the number of failures of random access based on the first-stage synchronization signal is greater than the fifth threshold, switch to random access based on the second-stage synchronization signal.

Optionally, the radio frequency unit 1101 is further configured to:
receive second indication information sent by the network-side device, where the second indication information is used to instruct the terminal to receive a second-stage synchronization signal associated with a second target first-stage synchronization signal, and forbid the terminal to perform random access on a PRACH resource associated with the second target first-stage synchronization signal.

Optionally, the radio frequency unit 1101 is further configured to:
send a random access message via a PRACH resource associated with the second-stage synchronization signal.

Optionally, an embodiment of this application further provides a terminal, including a processor, a memory, and a program or instructions stored in the memory and capable of running on the processor. When the program or instructions are executed by the processor, each process of the foregoing information transmission method embodiment is implemented, with the same technical effect achieved. To avoid repetition, details are not described herein again.

An embodiment of this application further provides a readable storage medium. The computer-readable storage medium stores a program or instructions. When the program or instructions are executed by a processor, each process of the foregoing information transmission method embodiment is implemented, with the same technical effect achieved. To avoid repetition, details are not described herein again.

The computer-readable storage medium is, for example, a read-only memory (ROM for short), a random access memory (RAM for short), a magnetic disk, or an optical disc.

As shown in FIG. 12, an embodiment of this application further provides an information transmission apparatus 1200. The apparatus is applied to a network-side device and includes:
a first sending module 1201, configured to send first indication information to a terminal via system information associated with a first-stage synchronization signal and/or a second-stage synchronization signal, where the first indication information is used to indicate an adjusted sending configuration parameter of the second-stage synchronization signal, where
the sending configuration parameter includes at least one of the following:
a synchronization raster;
a frequency-domain position;
a time-domain position;
a time-domain offset and/or a frequency-domain offset of the second-stage synchronization signal relative to the first-stage synchronization signal;
a mapping relationship between an index set of the first-stage synchronization signal and an index set of the second-stage synchronization signal;
a quantity of second-stage synchronization signals;
a sending period; and
a transmission state, where the transmission state includes: sending enabled or sending disabled.

Optionally, the first sending module 1201 is configured to:
send the first indication information to the terminal based on an access status of the terminal.

Optionally, before the first sending module 1201 sends the first indication information to the terminal, the apparatus further includes:
a third receiving module, configured to receive a first uplink signal sent by the terminal, where the first uplink signal is used to request the network-side device to adjust a sending configuration parameter of a second-stage synchronization signal.

Optionally, the first uplink signal includes a second Msg 1 or a signaling request message in a connected state.

Optionally, the first uplink signal includes identification information of the first-stage synchronization signal.

Optionally, the adjusted second-stage synchronization signal includes at least one second-stage synchronization signal associated with the first-stage synchronization signal.

Optionally, after the first sending module 1201 receives the first uplink signal sent by the terminal, the apparatus further includes:
a fourth receiving module, configured to receive a second uplink signal sent by the terminal, where the second uplink signal is used to request to adjust a sending configuration parameter of a second-stage synchronization signal associated with one or more other first-stage synchronization signals, and the other first-stage synchronization signal is a synchronization signal other than a first-stage synchronization signal corresponding to a PRACH resource for sending the first uplink signal.

Optionally, the apparatus further includes:
an eighth sending module, configured to: in a case that it is determined that a quantity of terminals performing access based on a second target first-stage synchronization signal is greater than or equal to a preset value, send second indication information to the terminal, where the second indication information is used to instruct the terminal to receive a second-stage synchronization signal associated with the second target first-stage synchronization signal, and forbid the terminal to perform random access on a PRACH resource associated with the second target first-stage synchronization signal.

It should be noted that this apparatus embodiment is an apparatus corresponding to the foregoing method. All implementations of the foregoing method embodiment are applicable to this apparatus embodiment, with the same technical effect achieved. Details are not described herein again.

An embodiment of this application further provides a network-side device, including a processor and a communication interface. The communication interface is configured to send first indication information to a terminal via system information associated with a first-stage synchronization signal and/or a second-stage synchronization signal, where the first indication information is used to indicate an adjusted sending configuration parameter of the second-stage synchronization signal, where
the sending configuration parameter includes at least one of the following:
a synchronization raster;
a frequency-domain position;
a time-domain position;
a time-domain offset and/or a frequency-domain offset of the second-stage synchronization signal relative to the first-stage synchronization signal;
a mapping relationship between an index set of the first-stage synchronization signal and an index set of the second-stage synchronization signal;
a quantity of second-stage synchronization signals;
a sending period; and
a transmission state, where the transmission state includes: sending enabled or sending disabled.

Optionally, the communication interface is configured to:
send the first indication information to the terminal based on an access status of the terminal.

Optionally, the communication interface is further configured to:
receive a first uplink signal sent by the terminal, where the first uplink signal is used to request the network-side device to adjust a sending configuration parameter of a second-stage synchronization signal.

Optionally, the first uplink signal includes a second Msg 1 or a signaling request message in a connected state.

Optionally, the first uplink signal includes identification information of the first-stage synchronization signal.

Optionally, the adjusted second-stage synchronization signal includes at least one second-stage synchronization signal associated with the first-stage synchronization signal.

Optionally, the communication interface is further configured to:
receive a second uplink signal sent by the terminal, where the second uplink signal is used to request to adjust a sending configuration parameter of a second-stage synchronization signal associated with one or more other first-stage synchronization signals, and the other first-stage synchronization signal is a synchronization signal other than a first-stage synchronization signal corresponding to a PRACH resource for sending the first uplink signal.

Optionally, the communication interface is further configured to:
in a case that it is determined that a quantity of terminals performing access based on a second target first-stage synchronization signal is greater than or equal to a preset value, send second indication information to the terminal, where the second indication information is used to instruct the terminal to receive a second-stage synchronization signal associated with the second target first-stage synchronization signal, and forbid the terminal to perform random access on a PRACH resource associated with the second target first-stage synchronization signal.

Optionally, an embodiment of this application further provides a network-side device, including a processor, a memory, and a program or instructions stored in the memory and capable of running on the processor. When the program or instructions are executed by the processor, each process of the foregoing information transmission method embodiment is implemented, with the same technical effect achieved. To avoid repetition, details are not described herein again.

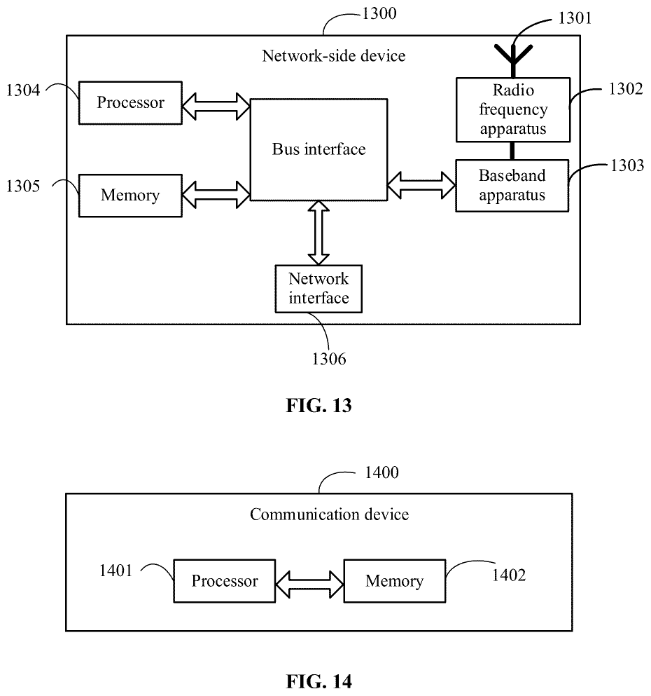

Specifically, an embodiment of this application further provides a network-side device. As shown in FIG. 13, the network-side device 1300 includes an antenna 1301, a radio frequency apparatus 1302, a baseband apparatus 1303, a processor 1304, and a memory 1305. The antenna 1301 is connected to the radio frequency apparatus 1302. In an uplink direction, the radio frequency apparatus 1302 receives information by using the antenna 1301, and sends the received information to the baseband apparatus 1303 for processing. In a downlink direction, the baseband apparatus 1303 processes to-be-sent information, and sends the information to the radio frequency apparatus 1302; and the radio frequency apparatus 1302 processes the received information and then sends the information out by using the antenna 1301.

The method performed by the access network device in the foregoing embodiment may be implemented in the baseband apparatus 1303. The baseband apparatus 1303 includes a baseband processor.

The baseband apparatus 1303 may include, for example, at least one baseband unit, where a plurality of chips are disposed on the baseband unit. As shown in FIG. 13, one of the chips is, for example, the baseband processor, connected to the memory 1305 by using a bus interface, to invoke a program in the memory 1305 to perform the operation of the network device shown in the foregoing method embodiment.

The access network device may further include a network interface 1306, where the interface is, for example, a common public radio interface (CPRI).

Specifically, the network-side device 1300 in this embodiment of this application further includes a program or instructions stored in the memory 1305 and capable of running on the processor 1304. When the processor 1304 invokes the program or instructions in the memory 1305, the method performed by each module shown in FIG. 12 is performed, with the same technical effect achieved. To avoid repetition, details are not described herein again.

An embodiment of this application further provides a readable storage medium. The readable storage medium stores a program or instructions. When the program or instructions are executed by a processor, each process of the foregoing information transmission method embodiment is implemented, with the same technical effect achieved. To avoid repetition, details are not described herein again.

The processor is a processor in the access network device described in the foregoing embodiments. The readable storage medium includes a computer-readable storage medium, such as a computer read-only memory ROM, a random access memory RAM, a magnetic disk, or an optical disc.

Optionally, as shown in FIG. 14, an embodiment of this application further provides a communication device 1400, including a processor 1401 and a memory 1402. The memory 1402 stores a program or instructions capable of running on the processor 1401. For example, when the communication device 1400 is a terminal, and the program or instructions are executed by the processor 1401, the steps of the foregoing information transmission method embodiment are implemented, with the same technical effect achieved. When the communication device 1400 is a network-side device, and the program or instructions are executed by the processor 1401, each step of the foregoing information transmission method embodiment is implemented, with the same technical effect achieved. To avoid repetition, details are not described herein again.

In addition, an embodiment of this application provides a chip. The chip includes a processor and a communication interface. The communication interface is coupled to the processor. The processor is configured to run a program or instructions to implement each process of the foregoing information transmission method embodiment, with the same technical effect achieved. To avoid repetition, details are not described herein again.

It should be understood that the chip provided in this embodiment of this application may also be referred to as a system-level chip, a system chip, a chip system, a system-on-chip, or the like.

In addition, an embodiment of this application provides a computer program or program product. The computer program or program product is stored in a storage medium. The computer program or program product is executed by at least one processor to implement each process of the foregoing information transmission method embodiment, with the same technical effect achieved. To avoid repetition, details are not described herein again.

An embodiment of this application further provides an information transmission system, including a terminal and a network-side device. The terminal may be configured to perform the steps of the foregoing information transmission method. The network-side device may be configured to perform the steps of the foregoing information transmission method.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, and certainly may alternatively be implemented by using hardware. However, in most cases, the former is a preferred implementation. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. An information transmission method, comprising:
receiving, by a terminal, first indication information sent by a network-side device via system information associated with a first-stage synchronization signal and/or a second-stage synchronization signal, wherein the first indication information is used to indicate an adjusted sending configuration parameter of the second-stage synchronization signal, wherein the sending configuration parameter comprises at least one of the following:
a synchronization raster;
a frequency-domain position;
a time-domain position;
a time-domain offset and/or a frequency-domain offset of the second-stage synchronization signal relative to the first-stage synchronization signal;
a mapping relationship between an index set of the first-stage synchronization signal and an index set of the second-stage synchronization signal;
a quantity of second-stage synchronization signals;
a sending period; and
a transmission state, wherein the transmission state comprises: sending enabled or sending disabled.

2. The method according to claim 1, wherein the method further comprises:
sending, by the terminal, a first uplink signal to the network-side device, wherein the first uplink signal is used to request the network-side device to adjust a sending configuration parameter of a second-stage synchronization signal.

3. The method according to claim 1, wherein after the receiving, by a terminal, first indication information sent by a network-side device via system information associated with a first-stage synchronization signal and/or a second-stage synchronization signal, the method further comprises:
determining, by the terminal, a resource position of the second-stage synchronization signal based on the sending configuration parameter, wherein the resource position comprises a time-domain position and/or a frequency-domain position; and
detecting the second-stage synchronization signal based on the resource position of the second-stage synchronization signal.

4. The method according to claim 2, wherein the sending, by the terminal, a first uplink signal to the network-side device comprises:
sending, by the terminal, the first uplink signal to the network-side device based on detected signal quality of a target signal, wherein
the target signal comprises the first-stage synchronization signal; and the signal quality comprises reference signal received power RSRP, reference signal received quality RSRQ, or a signal to interference plus noise ratio SINR.

5. The method according to claim 4, wherein the sending, by the terminal, the first uplink signal to the network-side device based on detected signal quality of a target signal comprises:
in a case that the terminal detects that signal quality of all first-stage synchronization signals is less than a first threshold, sending the first uplink signal to the network-side device.

6. The method according to claim 5, wherein the sending the first uplink signal to the network-side device comprises:
sending, by the terminal, the first uplink signal on a physical random access channel PRACH resource associated with a first-stage synchronization signal with highest signal quality.

7. The method according to claim 5, further comprising:
detecting, by the terminal, the second-stage synchronization signal based on the sending configuration parameter, obtaining signal quality of the second-stage synchronization signal, and sending a first Msg 1 or a Msg A for random access on a PRACH resource associated with any second-stage synchronization signal with signal quality greater than or equal to a second threshold; or
in a case that signal quality of the second-stage synchronization signal detected by the terminal is less than or equal to a third threshold, increasing transmit power to resend the first uplink signal or send a second uplink signal, wherein the second uplink signal is used to request to adjust a sending configuration parameter of a second-stage synchronization signal associated with one or more other first-stage synchronization signals, and the other first-stage synchronization signal is a synchronization signal other than the first-stage synchronization signal corresponding to the PRACH resource for sending the first uplink signal.

8. The method according to claim 4, wherein the target signal further comprises the second-stage synchronization signal;
wherein the sending, by the terminal, the first uplink signal to the network-side device based on detected signal quality of a target signal comprises:
in a case that detected signal quality of both the first-stage synchronization signal and the second-stage synchronization signal is less than a detection threshold for random access, sending, by the terminal, the first uplink signal to the network-side device via a resource associated with the first-stage synchronization signal or the second-stage synchronization signal.

9. The method according to claim 2, wherein the first uplink signal comprises a second Msg 1 or a signaling request message in a connected state; or,
wherein the first uplink signal comprises identification information of the first-stage synchronization signal; wherein the adjusted second-stage synchronization signal comprises at least one second-stage synchronization signal associated with the first-stage synchronization signal.

10. The method according to claim 1, further comprising at least one of the following:
in a case that a first-stage synchronization signal with signal quality greater than or equal to a first threshold is detected, sending, by the terminal, a first Msg 1 or a Msg A for random access on a PRACH resource associated with a first-stage synchronization signal with highest signal quality; and
sending, by the terminal based on detected signal quality of the first-stage synchronization signal, a first Msg 1 or a Msg A for random access via a PRACH resource associated with a first target first-stage synchronization signal, wherein the first target first-stage synchronization signal is a synchronization signal with signal quality greater than or equal to a fourth threshold among the first-stage synchronization signals.

11. The method according to claim 1, further comprising:
in a case that random access based on a first target synchronization signal fails, switching to random access based on a second target synchronization signal, wherein
each of the first target synchronization signal and the second target synchronization signal is one of the first-stage synchronization signal and the second-stage synchronization signal, and the first target synchronization signal is different from the second target synchronization signal.

12. The method according to claim 11, wherein the switching to random access based on a second target synchronization signal in a case that random access based on a first target synchronization signal fails comprises:
in a case that random access based on the first target synchronization signal fails, switching, by the terminal based on target information, to random access based on the second target synchronization signal, wherein
the target information comprises one of the following:
a switching indication sent by the network-side device; and
a relationship between the number of failures of random access and a fifth threshold.

13. The method according to claim 12, wherein in a case that the target information is the relationship between the number of failures of random access and the fifth threshold, the switching, by the terminal based on target information, to random access based on the second target synchronization signal in a case that random access based on the first target synchronization signal fails comprises:
in a case that random access based on the first-stage synchronization signal fails, switching, by the terminal, to random access based on the second-stage synchronization signal; and
in a case that random access based on the second-stage synchronization signal fails, if the number of failures of random access based on both the first-stage synchronization signal and the second-stage synchronization signal is less than or equal to the fifth threshold, switching to random access based on the first-stage synchronization signal; or,
wherein in a case that the target information is the relationship between the number of random access failures and the fifth threshold, the switching, by the terminal based on target information, to random access based on the second target synchronization signal in a case that random access based on the first target synchronization signal fails comprises:
in a case that random access based on the first-stage synchronization signal fails, if the number of failures of random access based on the first-stage synchronization signal is greater than the fifth threshold, switching, by the terminal, to random access based on the second-stage synchronization signal.

14. The method according to claim 1, further comprising:
receiving, by the terminal, second indication information sent by the network-side device, wherein the second indication information is used to instruct the terminal to receive a second-stage synchronization signal associated with a second target first-stage synchronization signal, and forbid the terminal to perform random access on a PRACH resource associated with the second target first-stage synchronization signal.

15. The method according to claim 14, further comprising:
sending, by the terminal, a random access message via a PRACH resource associated with the second-stage synchronization signal.

16. An information transmission method, comprising:
sending, by a network-side device, first indication information to a terminal via system information associated with a first-stage synchronization signal and/or a second-stage synchronization signal, wherein the first indication information is used to indicate an adjusted sending configuration parameter of the second-stage synchronization signal, wherein the sending configuration parameter comprises at least one of the following:
a synchronization raster;
a frequency-domain position;
a time-domain position;
a time-domain offset and/or a frequency-domain offset of the second-stage synchronization signal relative to the first-stage synchronization signal;
a mapping relationship between an index set of the first-stage synchronization signal and an index set of the second-stage synchronization signal;
a quantity of second-stage synchronization signals;
a sending period; and
a transmission state, wherein the transmission state comprises: sending enabled or sending disabled.

17. The method according to claim 16, wherein the sending, by a network-side device, first indication information to a terminal comprises:
sending, by the network-side device, the first indication information to the terminal based on an access status of the terminal.

18. The method according to claim 17, wherein before the sending, by the network-side device, the first indication information to the terminal, the method further comprises:
receiving, by the network-side device, a first uplink signal sent by the terminal, wherein the first uplink signal is used to request the network-side device to adjust a sending configuration parameter of a second-stage synchronization signal.

19. The method according to claim 16, further comprising:
in a case that it is determined that a quantity of terminals performing access based on a second target first-stage synchronization signal is greater than or equal to a preset value, sending, by the network-side device, second indication information to the terminal, wherein the second indication information is used to instruct the terminal to receive a second-stage synchronization signal associated with the second target first-stage synchronization signal, and forbid the terminal to perform random access on a PRACH resource associated with the second target first-stage synchronization signal.

20. A terminal, comprising a processor and a memory, wherein the memory stores a program or instructions capable of running on the processor, and when the program or instructions are executed by the processor, the processor is configured to perform:
receiving first indication information sent by a network-side device via system information associated with a first-stage synchronization signal and/or a second-stage synchronization signal, wherein the first indication information is used to indicate an adjusted sending configuration parameter of the second-stage synchronization signal, wherein
the sending configuration parameter comprises at least one of the following:
a synchronization raster;
a frequency-domain position;
a time-domain position;
a time-domain offset and/or a frequency-domain offset of the second-stage synchronization signal relative to the first-stage synchronization signal;
a mapping relationship between an index set of the first-stage synchronization signal and an index set of the second-stage synchronization signal;
a quantity of second-stage synchronization signals;
a sending period; and
a transmission state, wherein the transmission state comprises: sending enabled or sending disabled.
